(19) United States
(12) Patent Application Publication
(10) Pub. No.: US 2026/0249555 A1
(43) Pub. Date: Aug. 27, 2026

(54) DIRECT COLOR 3D PRINTING COLORING AND ADDITIVE MATERIAL TECHNOLOGY

(71) Applicant: Michael Hynding, South San Francisco, CA (US)

(72) Inventor: Michael Hynding, South San Francisco, CA (US)

(21) Appl. No.: 19/192,081

(22) Filed: Apr. 28, 2025

Related U.S. Application Data
(60) Provisional application No. 63/762,522, filed on Feb. 24, 2025.

(51) Int. Cl. B29C 64/329; B29C 64/336; B33Y 40/00

(52) U.S. Cl. CPC B29C 64/329; B29C 64/336; B33Y 40/00

(57) ABSTRACT

An apparatus for 3D printing includes one or more color dispensers, each including a hopper, a color auger, and a color auger motor coupled to the color auger. The color auger is configured to feed powdered substance from the hopper out a nozzle into a 3D printer. The apparatus includes a mounting bracket with a nozzle opening for each of the color dispensers. The mounting bracket is configured to mount to a side of the 3D printer. The 3D printer is configured to include a chamber opening corresponding to at least each nozzle opening. The apparatus includes a controller module configured to signal each color auger motor to rotate to deliver a prescribed amount of powdered substance to the chamber of the 3D printer. A main auger of the 3D printer mixes the powdered substance with printing material to color the printing material.

### CROSS-REFERENCES TO RELATED APPLICATIONS

This application claims the benefit of United States Provisional Patent Application Number 63/762,522 entitled "DIRECT COLOR 3D PRINTING COLORING TECHNOLOGY" and filed on February 24, 2025 for Michael Hynding, which is incorporated herein by reference.

### FIELD

This invention relates to three-dimensional ("3D") printers and more particularly relates to direct color and additive material dispensers added to a pellet/granule-based extruder 3D printer.

### BACKGROUND

Pellet/granule-based extruders for 3D printing are available on the open market. These are auger-based mechanisms that melt and force molten plastic out of a nozzle. As opposed to filament- based 3D printing, pellet-based extrusion utilizes raw plastic pellet material. The pellets/granules [hereinafter "pellets] for extruders are required to be in the size range from 3 millimeters ("mm") to 5 mm. The pellets are fed into the extruder by means of either a more traditional gravity fed hopper, or by an automatic continuous feed system which is pneumatically driven. With both methods of material delivery the raw pellets enter the extruder from the side in the exact same manner and load the melting chamber of the extruder. The rotating feed-screw auger then grabs pellets and forces them down into the heated barrel where the pellets are melted into molten plastic and thoroughly mixed prior to extrusion through the nozzle.

The hopper configuration for feeding the pellet/granule material is basically a funnel which holds a specified amount of raw pellets which is connected to the melt chamber input opening by means of a fitting which allows the pellets to freely flow into the extruder by the force of gravity.

Alternatively, the pneumatically powered automatic pellet material feeding system consists of a large vat or tub of raw pellet material which is remotely located. The remotely located source of pellets is connected via vacuum conveyance hose of sufficient length to the pellet extruder input opening. Raw pellet material is forced through the tube with pressurized air from the vat or tub to the extruder. Feeding is controlled through a control loop using a proximity sensor, relay and blower. This system is purchased as a complete freestanding unit off the shelf.

Traditionally, for the object being printed to be a particular color, the pellets must be the chosen color. For a multi-colored object, once a first color is printed, the pellets are stopped and the 3D printer is pointed to a waste area to extrude out pellets of the first color. Pellets of a second color are then fed into the 3D printer, and once the second color material starts coming out of the printing nozzle, printing with the second color is started. This current method required numerous pellets of various colors and produces a lot of waste.

### SUMMARY

An apparatus for direct color system for 3D printing includes one or more color dispensers, each including a hopper, a color auger, and a color auger motor coupled to the color auger. The color auger is configured to rotate and feed a powdered substance from the hopper out a nozzle into a chamber of a 3D printer. The apparatus includes a mounting bracket that includes a nozzle opening for each of the one or more color dispensers. The mounting bracket is configured to mount to a side of the chamber of the 3D printer. The 3D printer is configured to include a chamber opening corresponding to at least each nozzle opening. The apparatus includes a controller module configured to signal each color auger motor to rotate to deliver a prescribed amount of the powdered substance to the chamber of the 3D printer. A main auger of the 3D printer mixes the powdered substance with printing material to color the printing material and/or to add an additive to the printing material.

Another apparatus for 3D printing includes a filament feeder with a filament mounting bracket, a roller, and a filament motor. The filament motor is configured to rotate the roller to feed the filament into a chamber of a 3D printer. The filament mounting bracket is mounted to the 3D printer above the chamber and the 3D printer is modified to include a filament opening corresponding with the filament mounting bracket. The apparatus includes a controller module configured to signal the filament motor to feed the filament into the chamber of the 3D printer.

Another apparatus for direct color system for 3D printing includes one or more color dispensers, each with a hopper, a color auger, a color auger motor coupled to the color auger, and a vibrating motor. The color auger motor is configured to rotate the color auger and feed a powdered substance from the hopper out a nozzle into a chamber of a 3D printer. The vibrating motor is configured to vibrate the color dispenser during operation of the color auger of the color dispenser. The apparatus includes a mounting bracket with a nozzle opening for three color dispensers. The mounting bracket is configured to mount to a side of the chamber of the 3D printer. The 3D printer is modified to include a chamber opening corresponding to at least each of three nozzle openings. The apparatus includes a controller module configured to signal each color auger motor to rotate to deliver a prescribed amount of powdered substance to the chamber of the 3D printer. A main auger of the 3D printer mixes the powdered substance with printing material to color the printing material and/or to add an additive to the printing material where the controller module is configured to interface with executable code of the 3D printer. The controller module provides a GUI with fields configured to be modified by a user to program color information for various parts of an object being printed.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating a color dispenser, according to various embodiments;

FIG. 1B is a top view further illustrating the color dispenser of FIG. 1A, according to various embodiments;

FIG. 2A is a back view further illustrating the color dispenser of FIG. 1A, according to various embodiments;

FIG. 2B is a front view further illustrating the color dispenser of FIG. 1A, according to various embodiments;

FIG. 3A is a side view further illustrating the color dispenser of FIG. 1A, according to various embodiments;

FIG. 3B is a bottom view further illustrating the color dispenser of FIG. 1A, according to various embodiments;

FIG. 4 is an exploded view further illustrating the color dispenser of FIG. 1A, according to various embodiments;

FIG. 5A is a top view further illustrating the color dispenser of FIG. 1A with a section line, according to various embodiments;

FIG. 5B is a section view A-A further illustrating the color dispenser of FIG. 1A, according to various embodiments;

FIG. 6A is a perspective view further illustrating the color dispenser of FIG. 1A with an exploded view of the color dispenser, an extension hopper and a lid, according to various embodiments;

FIG. 6B is a perspective view further illustrating the color dispenser of FIG. 1A with an assembled view of the color dispenser, the extension hopper, and the lid of FIG. 6A, according to various embodiments;

FIG. 7A is a perspective view of three color dispensers and a mounting bracket prior to insertion into the mounting bracket, according to various embodiments;

FIG. 7B is a perspective view of three color dispensers and a mounting bracket after insertion into the mounting bracket, according to various embodiments;

FIG. 8A is a perspective view of a mounting bracket for color dispensers and nozzle plugs for openings in the mounting bracket, according to various embodiments;

FIG. 8B is a perspective view of the mounting bracket for color dispensers and the nozzle plugs inserted into the openings in the mounting bracket, according to various embodiments;

FIG. 9A is a top view of the mounting bracket of FIG. 8A, according to various embodiments;

FIG. 9B is a front view of the mounting bracket of FIG. 8A, according to various embodiments;

FIG. 9C is a side view of the mounting bracket of FIG. 8A, according to various embodiments;

FIG. 9D is a front perspective view of the mounting bracket of FIG. 8A, according to various embodiments;

FIG. 9E is a back perspective view of the mounting bracket of FIG. 8A, according to various embodiments;

FIG. 10 is a section view of a 3D printer without color dispensers, according to various embodiments;

FIG. 11 is a section view of the 3D printer of FIG. 10 with color dispensers, according to various embodiments;

FIG. 12A is a side view of a 3D printer with a hopper for 3D printing pellets without color dispensers, according to various embodiments;

FIG. 12B is a front view of the 3D printer of FIG. 12A without color dispensers, according to various embodiments;

FIG. 12C is a perspective view of the 3D printer of FIG. 12A without color dispensers, according to various embodiments;

FIG. 13A is a side view of a 3D printer with a pellet hose feed and without color dispensers, according to various embodiments;

FIG. 13B is a front view of the 3D printer of FIG. 13A with a pellet hose feed and without color dispensers, according to various embodiments;

FIG. 13C is a perspective view of the 3D printer of FIG. 13A with a pellet hose feed and without color dispensers, according to various embodiments;

FIG. 14A is a dashed side view of the 3D printer of FIG. 13A with a mounting bracket for color dispensers without the color dispensers inserted, according to various embodiments;

FIG. 14B is a dashed front view of the 3D printer of FIG. 13A with a mounting bracket for color dispensers without the color dispensers inserted, according to various embodiments;

FIG. 14C is a perspective view of the 3D printer of FIG. 13A with a mounting bracket for color dispensers without the color dispensers inserted, according to various embodiments;

FIG. 15A is a dashed side view of the 3D printer of FIG. 13A with a mounting bracket for color dispensers with the color dispensers inserted, according to various embodiments;

FIG. 15B is a dashed front view of the 3D printer of FIG. 13A with a mounting bracket for color dispensers with the color dispensers inserted, according to various embodiments;

FIG. 15C is a perspective view of the 3D printer of FIG. 13A with a mounting bracket for color dispensers with the color dispensers inserted, according to various embodiments;

FIG. 16A is a side view of the 3D printer of FIG. 13A with a mounting bracket for color dispensers with the color dispensers inserted, according to various embodiments;

FIG. 16B is a section view of the 3D printer of FIG. 16A with a mounting bracket for color dispensers with the color dispensers inserted, according to various embodiments;

FIG. 17A is a back view of the 3D printer of FIG. 13A with a mounting bracket and color dispensers inserted into the mounting bracket, according to various embodiments;

FIG. 17B is a section view of the 3D printer of FIG. 13A with a mounting bracket and color dispensers inserted into the mounting bracket, according to various embodiments;

FIG. 18A is a side view of the 3D printer of FIG. 13A and a section D-D' line, according to various embodiments;

FIG. 18B is a section D-D' view of the 3D printer of FIG. 18A, according to various embodiments;

FIG. 19A is a perspective view of a 3D printer with a pellet hose feed, a mounting bracket and three color dispensers and a filament feeder, according to various embodiments;

FIG. 19B is a dashed side view of the 3D printer of FIG. 19A with a pellet hose feed, a mounting bracket and three color dispensers and a non-dashed view of the filament feeder, according to various embodiments;

FIG. 20A is an opposite side view of the 3D printer of FIG. 19A with a pellet hose feed, a mounting bracket and three color dispensers and the filament feeder, according to various embodiments;

FIG. 20B is a section view of the 3D printer of FIG. 20A, according to various embodiments;

FIG. 21A is a perspective view of the 3D printer of FIG. 13A with a spacer bracket between a fan and the 3D printer where the spacer bracket is configured for a camera, according to various embodiments;

FIG. 21B is a closeup perspective view of the fan, spacer bracket, and 3D printer of FIG. 21A, according to various embodiments;

FIG. 21C is a closeup exploded perspective view of the fan, spacer bracket, and 3D printer of FIG. 21A, according to various embodiments;

FIG. 22A is a top view of the spacer bracket of FIG. 21A and vent panel of the 3D printer, according to various embodiments;

FIG. 22B is front view of the spacer bracket and the vent panel of the 3D printer behind the spacer bracket of FIG. 21A, according to various embodiments;

FIG. 22C is a section E-E' view of the spacer bracket of FIG. 21A, according to various embodiments;

FIG. 22D is a side view of the spacer bracket of FIG. 21A and the vent panel of the 3D printer, according to various embodiments;

FIG. 22E is a back perspective view of the spacer bracket of FIG. 21A and the vent panel of the 3D printer, according to various embodiments;

FIG. 22F is another back perspective view of the spacer bracket of FIG. 21A and the vent panel of the 3D printer, according to various embodiments;

FIG. 23 is a schematic block diagram of a direct color system of a 3D printer with three color dispensers, according to various embodiments;

FIG. 24 is a perspective view of the system of FIG. 23, according to various embodiments;

FIG. 25 is a diagram of a graphical user interface for the 3D printer with color dispensers, according to various embodiments; and

FIG. 26 is a schematic flowchart diagram illustrating a method for using a 3D printer with color dispensers, according to various embodiments.

### DETAILED DESCRIPTION

Reference throughout this specification to "one embodiment," "an embodiment," or similar language means that a particular feature, structure, or characteristic described in connection with the embodiment is included in at least one embodiment. Thus, appearances of the phrases "in one embodiment," "in an embodiment," and similar language throughout this specification may, but do not necessarily, all refer to the same embodiment, but mean "one or more but not all embodiments" unless expressly specified otherwise. The terms "including," "comprising," "having," and variations thereof mean "including but not limited to" unless expressly specified otherwise. An enumerated listing of items does not imply that any or all of the items are mutually exclusive and/or mutually inclusive, unless expressly specified otherwise. The terms "a," "an," and "the" also refer to "one or more" unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a "circuit," "module," or "system." Furthermore, aspects of the present invention may take the form of a computer program product embodied in one or more computer readable medium(s) having program code embodied thereon.

Some of the functional units described in this specification have been labeled as modules, in order to more particularly emphasize their implementation independence. For example, a module may be implemented as a hardware circuit comprising custom very large scale integrated ("VLSI") circuits or gate arrays, off-the-shelf semiconductors such as logic chips, transistors, or other discrete components. A module may also be implemented in programmable hardware devices such as a field programmable gate array ("FPGA"), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory ("RAM"), a read-only memory ("ROM"), an erasable programmable read- only memory ("EPROM" or Flash memory), a static random access memory ("SRAM"), a portable compact disc read-only memory ("CD-ROM"), a digital versatile disk ("DVD"), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture ("ISA") instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network ("LAN") or a wide area network ("WAN"), or the connection may be made to an external computer (for example, through the Internet using an Internet Service Provider). In some embodiments, electronic circuitry including, for example, programmable logic circuitry, field- programmable gate arrays ("FPGA"), or programmable logic arrays ("PLA") may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of "and/or" includes any single item in the list or a combination of items in the list. For example, a list of A, B and/or C includes only A, only B, only C, a combination of A and B, a combination of B and C, a combination of A and C or a combination of A, B and C. As used herein, a list using the terminology "one or more of' includes any single item in the list or a combination of items in the list. For example, one or more of A, B and C includes only A, only B, only C, a combination of A and B, a combination of B and C, a combination of A and C or a combination of A, B and C. As used herein, a list using the terminology "one of' includes one and only one of any single item in the list. For example, "one of A, B and C" includes only A, only B or only C and excludes combinations of A, B and C.

An apparatus for direct color system for 3D printing includes one or more color dispensers, each including a hopper, a color auger, and a color auger motor coupled to the color auger. The color auger is configured to rotate and feed a powdered substance from the hopper out a nozzle into a chamber of a 3D printer. The apparatus includes a mounting bracket that includes a nozzle opening for each of the one or more color dispensers. The mounting bracket is configured to mount to a side of the chamber of the 3D printer. The 3D printer is configured to include a chamber opening corresponding to at least each nozzle opening. The apparatus includes a controller module configured to signal each color auger motor to rotate to deliver a prescribed amount of the powdered substance to the chamber of the 3D printer. A main auger of the 3D printer mixes the powdered substance with printing material to color the printing material and/or to add an additive to the printing material.

In some embodiments, the one or more color dispensers include two or more color dispensers and the controller module is configured to combine different color powdered substances from the two or more color dispensers to provide a printing material colored using a mixture of the powdered substances from the two or more color dispensers. In other embodiments, the two or more color dispensers with the powdered substance include a color dispenser with a cyan color powder, a color dispenser with a magenta color powder, and a color dispenser with a yellow color powder, where the controller module is configured to mix the cyan color powder, the magenta color powder, and the yellow color powder to achieve a desired color from a cyan-magenta-yellow ("CMY") color scheme.

In some embodiments, each of the one or more color dispensers includes a vibrating motor configured to vibrate the color dispenser during operation of the color auger of the color dispenser. In other embodiments, the apparatus includes an extension hopper configured to couple to a top of the hopper of a color dispenser of the one or more color dispensers. The extension hopper is configured to add additional capacity to the color dispenser for the powdered substance. In other embodiments, the extension hopper is configured to be stackable where two or more extension hoppers are connectable to the hopper of the one or more color dispensers.

In some embodiments, the controller module is configured to interface with executable code of the 3D printer where the controller module provides a graphical user interface ("GUI") with fields configured to be modified by a user to program color information for various parts of an object being printed. In other embodiments, the 3D printer is configured for 3D printing pellets. In other embodiments, the apparatus includes a filament feeder attached to the 3D printer. The filament feeder is configured to feed a filament into the chamber in place of 3D printing pellets. In other embodiments, the filament feeder includes a filament mounting bracket, a roller, and a filament motor. The filament motor is configured to rotate the roller as directed by the controller module to feed the filament into the chamber. The filament mounting bracket is mounted to the 3D printer above the chamber and the 3D printer is modified to include a filament opening corresponding with the filament mounting bracket. In other embodiments, the one or more color dispensers each include a wedge shape with a narrow portion of the wedge shape at the nozzle. In other embodiments, the apparatus includes a camera directed into the chamber where the camera providing a view of the interior of the chamber.

Another apparatus for 3D printing includes a filament feeder with a filament mounting bracket, a roller, and a filament motor. The filament motor is configured to rotate the roller to feed the filament into a chamber of a 3D printer. The filament mounting bracket is mounted to the 3D printer above the chamber and the 3D printer is modified to include a filament opening corresponding with the filament mounting bracket. The apparatus includes a controller module configured to signal the filament motor to feed the filament into the chamber of the 3D printer.

In some embodiments, the apparatus includes one or more color dispensers, each including a hopper, a color auger, and a color auger motor coupled to the color auger. The color auger is configured to rotate and feed the powdered substance from the hopper out a nozzle into a chamber of the 3D printer. The apparatus includes a mounting bracket with a nozzle opening for each of the one or more color dispensers. The mounting bracket is configured to mount to a side of the chamber of the 3D printer. The 3D printer is configured to include a chamber opening corresponding to at least each nozzle opening. The controller module is configured to signal each color auger motor to rotate to deliver a prescribed amount of the powdered substance to the chamber of the 3D printer. A main auger of the 3D printer mixes the powdered substance with printing material to color the printing material.

In some embodiments, the one or more color dispensers include two or more color dispensers and the controller module is configured to combine the powdered substance from the two or more to provide a printing material colored using a mixture of the powdered substance from the two or more color dispensers. In other embodiments, each of the one or more color dispensers include a vibrating motor configured to vibrate the color dispenser during operation of the color auger of the color dispenser. In other embodiments, each of the one or more hoppers includes an extension hopper configured to couple to a top of the hopper of a color dispenser of the one or more color dispensers. The extension hopper is configured to add additional capacity to the color dispenser for the powdered substance.

In other embodiments, the controller module is configured to interface with executable code of the 3D printer. The controller module provides a GUI that includes fields configured to be modified by a user to program color information for various parts of an object being printed. In other embodiments, the 3D printer is configured for 3D printing pellets.

Another apparatus for direct color system for 3D printing includes one or more color dispensers, each with a hopper, a color auger, a color auger motor coupled to the color auger, and a vibrating motor. The color auger motor is configured to rotate the color auger and feed powdered substance from the hopper out a nozzle into a chamber of a 3D printer. The vibrating motor is configured to vibrate the color dispenser during operation of the color auger of the color dispenser. The apparatus includes a mounting bracket with a nozzle opening for three color dispensers. The mounting bracket is configured to mount to a side of the chamber of the 3D printer. The 3D printer is modified to include a chamber opening corresponding to at least each of three nozzle openings. The apparatus includes a controller module configured to signal each color auger motor to rotate to deliver a prescribed amount of the powdered substance to the chamber of the 3D printer. A main auger of the 3D printer mixes the powdered substance with printing material to color the printing material and/or to add an additive to the printing material where the controller module is configured to interface with executable code of the 3D printer. The controller module provides a GUI with fields configured to be modified by a user to program color information for various parts of an object being printed.

In some embodiments, the apparatus includes an extension hopper configured to couple to a top of the hopper of a color dispenser of the one or more color dispensers. The extension hopper is configured to add additional capacity to the color dispenser for the powdered substance. In other embodiments, the apparatus includes a filament feeder attached to the 3D printer. The filament feeder is configured to feed a filament into the chamber in place of 3D printing pellets.

A method for adding powdered colorant and/or powdered additives to the extrusion process in 3D printing and injection molding of pellet or granule raw material is described herein. This method of Fused Deposition Modeling ("FDM") technology utilizes a unique type of extruder 3D printer. Raw plastic pellets are fed directly into a heated melt zone for melting, mixing and extrusion. The embodiments described herein add colorants (e.g., powdered substance) directly into the melt zone of the extruder, thereby mixing the colorants directly into the molten plastic for mixing immediately prior to extrusion out of the printer nozzle. This type of extruder 3D printer employs a motor driven auger applying an Archimedes Screw principal to develop pressure and force the molten plastic out of the extruder nozzle. The types of plastic used in this process includes but is not limited to polyethylene terephthalate ("PET"), polyethylene terephthalate glycol ("PETG"), acrylonitrile butadiene styrene ("ABS"), polylactic acid ("PLA"), or the like.

The embodiments described herein are the means to add the colorant/additive dispensers to existing pellet extruder equipment. As such, the embodiments described herein are designed to be integrated (installed) onto any number of pellet extruders available in the free market. Furthermore, the small scale of this system and high colorant powder throughput of our devices allows for installation on sizes from the smallest benchtop 3D printer to the large scale industrial machines. In other embodiments, the color dispensers and associated controls and software may be integrated directly into a 3D printer.

The embodiments described herein are designed to fit on any commonly available 3D printing pellet extruder as an addition. This is made possible by a crucial aspect of the design which, in some embodiments, allows for its installation onto an extruder 3D printer with the requirement of a 1-1/2 inches x 1 inch mounting bracket. This mounting bracket fits into a hole of the same size which will be cut as part of the installation. The mounting bracket, in some embodiments, gets fastened into place utilizing two existing machine screws that are already part of the extruder. Physical templates for cutting out the holes are included with the product. Ultimately, the small size allows this system to be incorporated into a full range of pellet extruder sizes from the smallest bench-top scale extruder to the biggest large-format commercial 3D printer mounted on a robotic arm. The highly variable and precise feed rate of this invention allows this system to deliver colorant/additive powder (which may be referred to herein as "powdered substance") to match any raw pellet feeding rate.

The wedge- shaped color dispenser body is unique and is optimized to allow three color dispensers to have feed-screw barrel ends converge in the same very small area available at a chamber of the 3D printer at the top of the melt chamber. These wedge-shaped dispensers fit together like pie pieces adjacent to one another when inserted into the mounting bracket. The color dispenser body is also designed to minimize the distance between the motors to zero. Also, the hopper volume is maximized to contain the most colorant powder possible while fitting within the constraints of the pie shape form factor.

For a Cyan-Magenta-Yellow ("CMY") colorant application, with three dispensers dispensing colorants/additives such that one is Cyan, one Magenta and one Yellow, well over 8,000+ color combination can be achieved with only the three colorants. The large number of colors are achieved by precisely delivering fine amounts of the three colorants each in measured amounts in exact proportion to and at the correct rate to color the plastic that is being processed through the extruder. Depending on what combination of colorants are added or not added to the extrusion, a different color and translucency is achieved. Colorant powder is typically added at the concentration of between 1 percent ("%") and 3% of the raw material being processed by weight.

Color changes and additive mixing take place rapidly with this system due to the close proximity of the colorant addition to the point of extrusion. The specially formulated proprietary colorant powders are based on varying iron oxides and mica powders used in the industry for glass blowing, acrylic arts and crafts, paint making, concrete and stucco. The proprietary colorant powder mixtures contain anti-caking agent(s) and are specifically formulated to facilitate powder flow through the color dispensers. Typically, the color powders have particles on the order of microns while pellets for the 3D printer are much larger and are often around 3 millimeters.

Additives can be fed into the extruder in the same fashion as the colorant. A diverse, powerful range of powdered additives can be used in conjunction with or in lieu of color powders. These additives include but are not limited to; fire retardant, glow in the dark hues, glitter, antimicrobial powder, ultraviolet ("UV") resistance powder, and heat resistance powder.

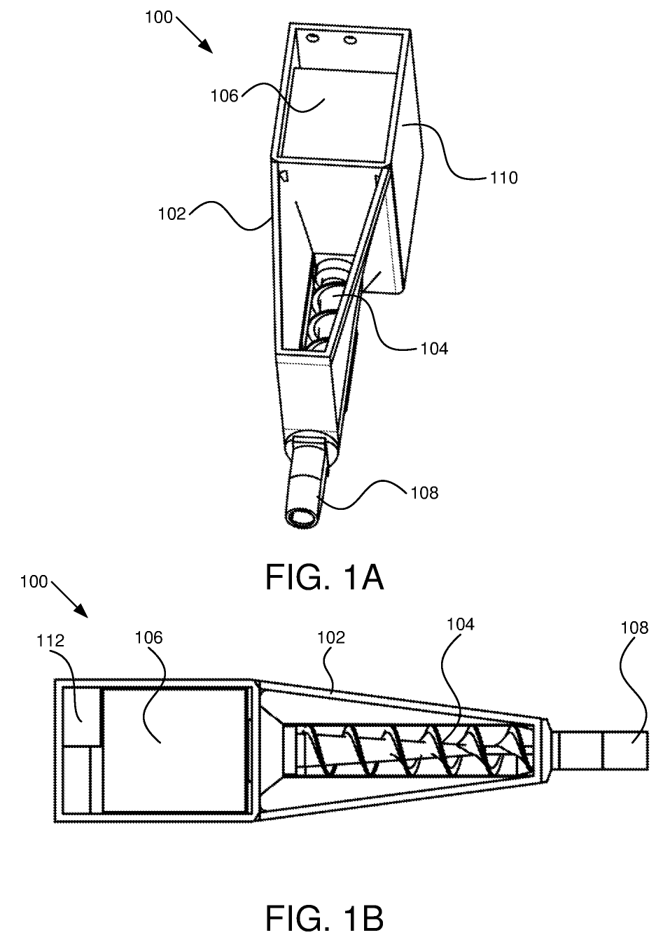

FIG. 1A is a perspective view and FIG. 1B is a top view illustrating a color dispenser 100, according to various embodiments. The color dispensers 100 each include a small one- piece housing unit which contains a color auger motor 106, a motorized feed-screw color auger 104, an integral hopper 102, a motor compartment 110, and feed-screw barrel surrounding the color auger 104 to supply a powdered substance, such as powdered colorants or powdered additives out of the end of the barrel through a nozzle 108. With the nozzle 108 of the dispenser inserted into the melt chamber of the extruder 3D printer, the colorant is dispensed into the melt chamber instantly mixing with the melting pellet material, which is often a plastic substance.

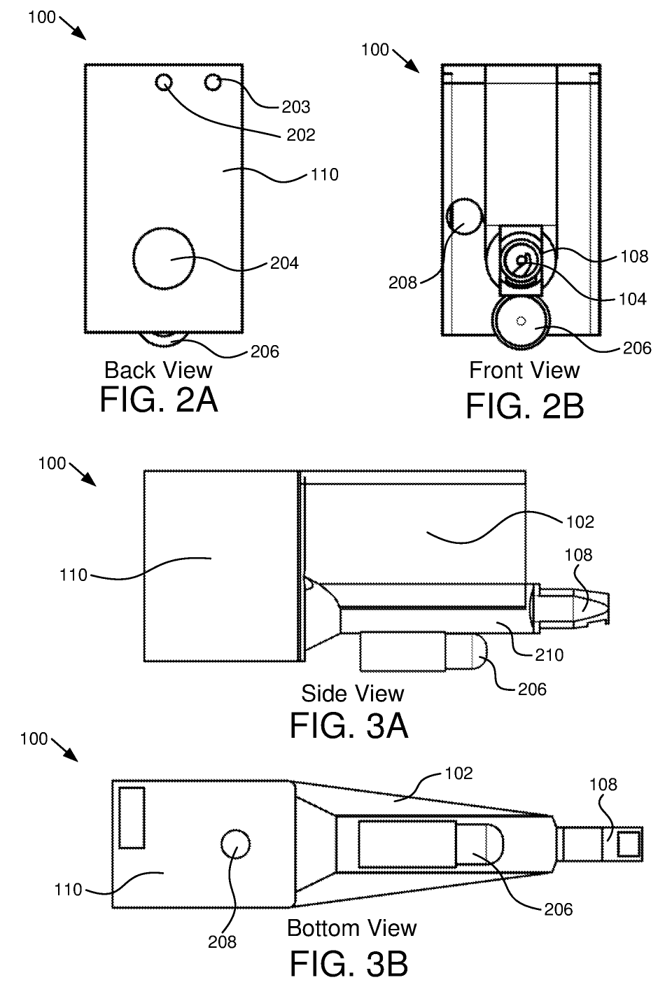

FIG. 2A is a back view and FIG. 2B is a front view further illustrating the color dispenser 100 of FIG. 1A, according to various embodiments. FIG. 3A is a side view and FIG. 3B is a bottom view further illustrating the color dispenser 100 of FIG. 1A, according to various embodiments. The color dispenser 100 includes a power light 202, a feed light 203, an auger opening 204, a vibrating motor 206, a wire opening 208, and a feed-screw barrel 210, which are described below.

The color dispenser 100 includes an auger opening 204 configured to allow the color auger 104 to be inserted during assembly or maintenance. The one-piece housing unit of the color dispenser 100, in some embodiments, includes a vibrating motor 206 (unbalanced mass) which necessarily vibrates through the general vicinity of the hopper 102 to jostle and agitate the powder.

In some embodiments, the vibrating motor 206 is located directly on the feed-screw barrel 210 at a point of dispensing. In some embodiments, the color auger motor 106 and vibrating motor 206 operate together whenever the powdered substance is being dispensed. In some embodiments, each dispenser includes a power light 202, which may be a power indicating light- emitting-diode ("LED"), as well as a feed light 203, which also may be an LED. The power light 202, in some embodiments, is illuminated any time there is power to the direct color system and/or the color dispenser 100. The feed light 203 illuminates when the color dispenser 100 is dispensing colorant or additive powder while the color auger motor 106 is rotating.

The design of each color dispenser 100, in some embodiments, uses a one-piece body which has a see-though, semi-transparent hopper 102, which, is useful as it allows a visual indicator of colorant powder level for the operator to see during use. In some embodiments, the feed-screw color auger 104 is intentionally brightly colored (neo-orange or bright red) to provide maximum contrast to enhance visibility of the color auger 104 in action and at rest, which is helpful in ensuring an adequate level of colorant powder is maintained in the hopper 102 of the color dispenser 100. The semi- transparent hopper 102 and brightly colored color auger 104 also assist in troubleshooting as well.

The color dispensers 100, in some embodiments, easily snap in and out of a mounting bracket on the 3D printer and are completely interchangeable in which of the three positions they are inserted into. In some embodiments, a wiring harness (not shown) to each individual dispenser has a useful length approximately 12" to 18", where the wiring harness is loomed separately from the other two dispensers allowing the wiring harness to be manipulated and serviced individually while the other two are still installed in the mounting bracket. In some embodiments, the three separate wiring harnesses merge together and then continue back to the connection at a controller, which may be termed the direct color system controller. A portion of the wiring is fed through the wire opening 208.

The color auger motors 106 which drive the color auger 104 in each color dispenser 100, in some embodiments, are precise, compact servo motors. These color auger motors 106, in some embodiments, are controlled to very precise angular velocities (rpm) and discrete run times. The color augers 104, in some embodiments, are microfine and when combined with the color auger motors 106 are very precise in their delivery of colorant/additive powder (e.g., powdered substance or color powder).

In some embodiments, the color auger motors 106 of the color dispensers 100, the power lights 202 and feed lights 203 are powered through and controlled by a microprocessor executing code stored on computer readable storage media, which is non-transitory. In some embodiments, the color dispensers 100 are each connected to the microcontroller and a custom-built circuit board with a wiring harness. In some embodiments, the microprocessor is a standard off-the- shelf commodity running proprietary code written in C++. In other embodiments, the color auger motors 106 of the color dispensers 100, the power lights 202 and feed lights 203 are powered through and controlled by a programmable hardware device and/or hardware circuits.

In some embodiments, a digital step motor controller is used to drive the color auger motors 106 of the three color dispensers 100 individually. In some embodiments, the system includes three motor control channels, one for Cyan, one for Magenta and one for Yellow color dispensers 100. In other embodiments, the direct color system includes four or five color dispensers 100 and associated motor control channels. In some examples, in addition to cyan, magenta, and yellow color powders, there are additional color dispensers 100 to dispense white and/or black color powders. In other embodiments, additional color dispensers 100 add an additive or other substance, such as glitter, an ultraviolet ("UV") stabilizer, a metal powder, saw dust, copper dust, aluminum dust, or the like. In some embodiments, the direct color system is powered from a single 5 volt ("V"), 3 ampere ("A") power supply. In other embodiments, the direct color system is powered from another source. In some embodiments, the microcontroller has a physical reset button as well as a universal serial bus ("USB") port for wired use, which can also be accomplished with a custom printed circuit board instead of using an off-the-shelf microcontroller.

While the designs in the described embodiments incorporate three (3) color dispensers 100, in other embodiments more than three color dispensers may fit in a bracket and be installed on larger scale extruders, which would not only exponentially increase the combination of possibilities but also may provide redundancy for critical industrial applications. As few as one dispenser can be installed and operated if so desired.

In some embodiments, the motor compartment 110 includes an auger opening 204 configured for assembly of the color dispenser 100. The auger opening 204 is sized for the color auger 104 to fit through into the feed-screw barrel 210 before insertion and connection of the color auger motor 106. In some embodiments, after the color auger motor 106 is inserted, a motor spacer 112 is placed in the motor compartment 110 to hold the color auger motor 106 in place.

In some embodiments, a color cap is inserted into the auger opening 204 after assembly where the color of the color cap, in some embodiments, corresponds to the powdered substance in the hopper 102. In some embodiments, the motor compartment 110 includes one or more wiring openings 208 configured for connection of the wiring harness to the color auger motor 106, the vibrating motor 206, the power light 202, and the feed light 203.

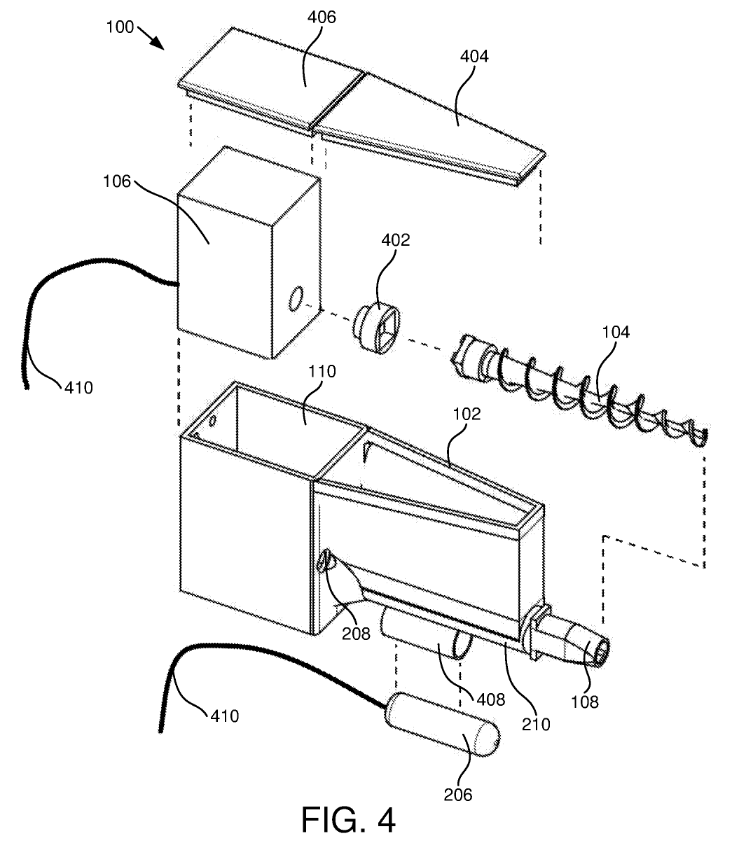

FIG. 4 is an exploded view further illustrating the color dispenser 100 of FIG. 1A, according to various embodiments. FIG. 4 depicts the hopper 102, the color auger 104, the color auger motor 106, the nozzle 108, the motor compartment 110, openings for the power light 202 and feed light 203, the vibrating motor 206, the wiring opening 208, and the feed-screw barrel 210.

In addition, FIG. 4 depicts a motor/auger coupler 402. In some embodiments, the motor/auger coupler 402 is made of a flexible material, such as rubber. In other embodiments, the motor/auger coupler 402 is made of plastic, metal, a 3D printing material, or other substance. The motor/auger coupler 402 includes an opening or other coupler on one end to couple to the color auger 104 and an opening or coupler on the other end configured to connect to a shaft of the color auger motor 106.

FIG. 4 also depicts a hopper lid 404 and a motor compartment lid 406. The hopper lid 404 and the motor compartment lid 406, in some embodiments, are configured to snap into the hopper 102 and the motor compartment 110 respectively. In some embodiments, the hopper lid 404 and the motor compartment lid 406 are made of a resilient material and form a tight fit to the hopper 102 and motor compartment 110. FIG. 4 depicts a vibrating motor bracket 408 configured to retain the vibrating motor 206. The color auger motor 106 and the vibrating motor 206 include wiring 410 configured to connect to the wiring harness.

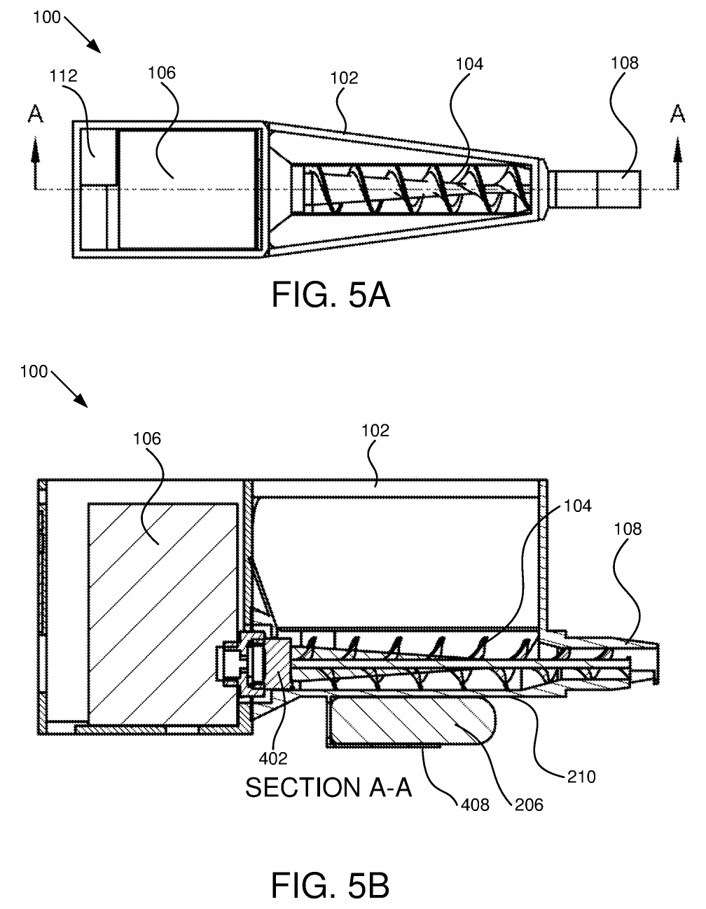

FIG. 5A is a top view further illustrating the color dispenser 100 of FIG. 1A with a section line, according to various embodiments. FIG. 5B is a section view A-A further illustrating the color dispenser 100 of Figure lA, according to various embodiments. FIG. 5B depicts the motor/auger coupler 402 connecting the color auger 104 to the color auger motor 106. FIG. 5B also depicts how the color auger 104 is positioned with respect to the nozzle 108 and how the feed-screw barrel 210 is positioned with respect to the vibrating motor 206 and vibrating motor bracket 408. Note that the color auger motor 106 is positioned forward towards the hopper 102 so there is space behind the color auger motor 106 for the motor spacer 112.

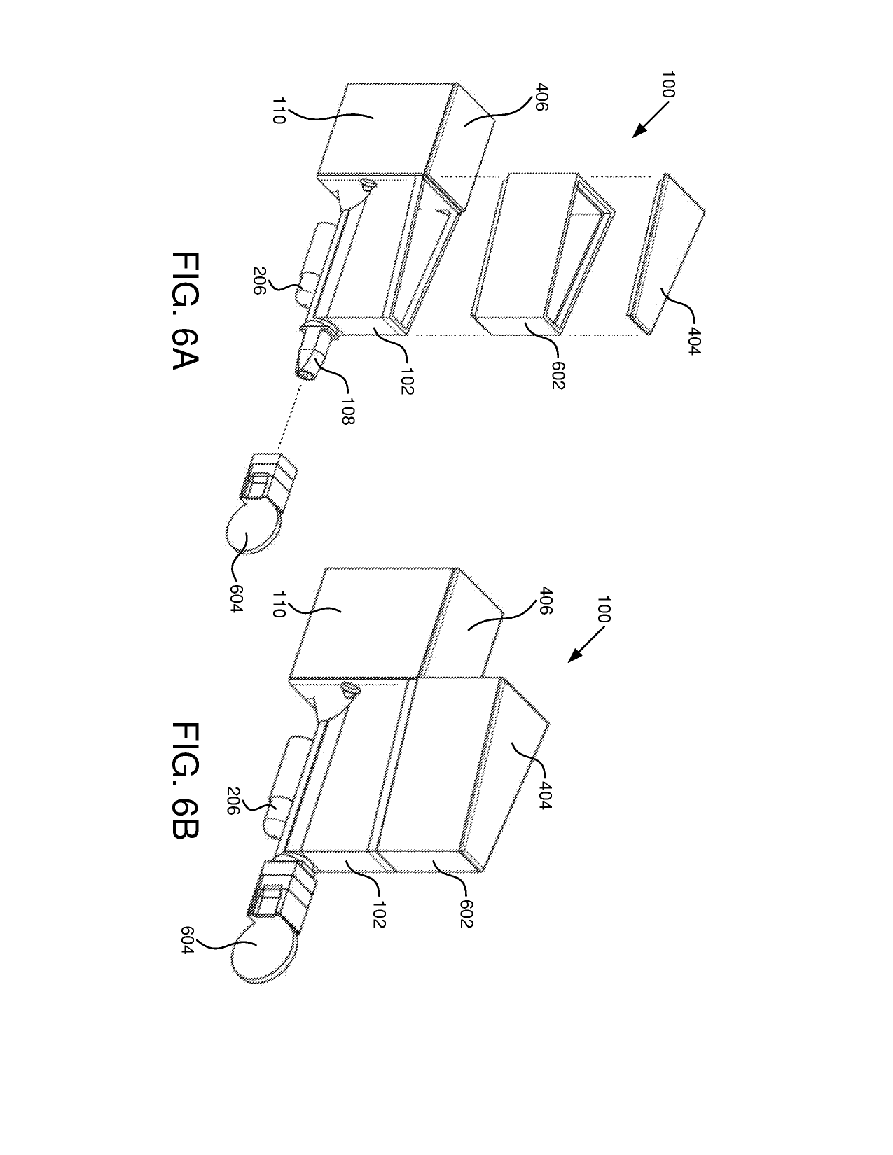

FIG. 6A is a perspective view further illustrating the color dispenser 100 of FIG. 1A with an exploded view of the color dispenser 100, an extension hopper 602 and a hopper lid 404, according to various embodiments. FIG. 6B is a perspective view further illustrating the color dispenser 100 of Figure lA with an assembled view of the color dispenser 100, the extension hopper 602, and the hopper lid 404 of FIG. 6A, according to various embodiments. The motor compartment lid 406 is also depicted in FIGS. 6A and 6B. FIGS. 6A and 6B also depict a nozzle cap 604 configured to cover the nozzle 108 when not in use. The nozzle cap 604 keeps the nozzle 108 from spilling powdered substance.

The extension hopper 602 is configured to snap on modularly to a hopper 102 or to another extension hopper 602 and can be stacked more than one high. In some embodiments, each extension hopper 602 is approximately one inch high and affords for an entire inch in height of colorant/additive powder to be added directly on the dispenser for each extender added. Other size extension hoppers 602 also scale up the amount of colorant/additive powder available to the hopper 102. Where a tube is used, the tube may include vibrating motors to move along the powdered substance. The extension hopper 602 allows a user to double, triple, etc. an amount of colorant loaded up for each color dispenser 100 for a particular print job. In other embodiments, the hopper 102 has a tube with powdered substance or other substance fed to the hopper 102 or to replace the hopper 102. The snap-on hopper lid 404 is configured to be used to cap the top of the extension hopper 602 and the hopper 102.

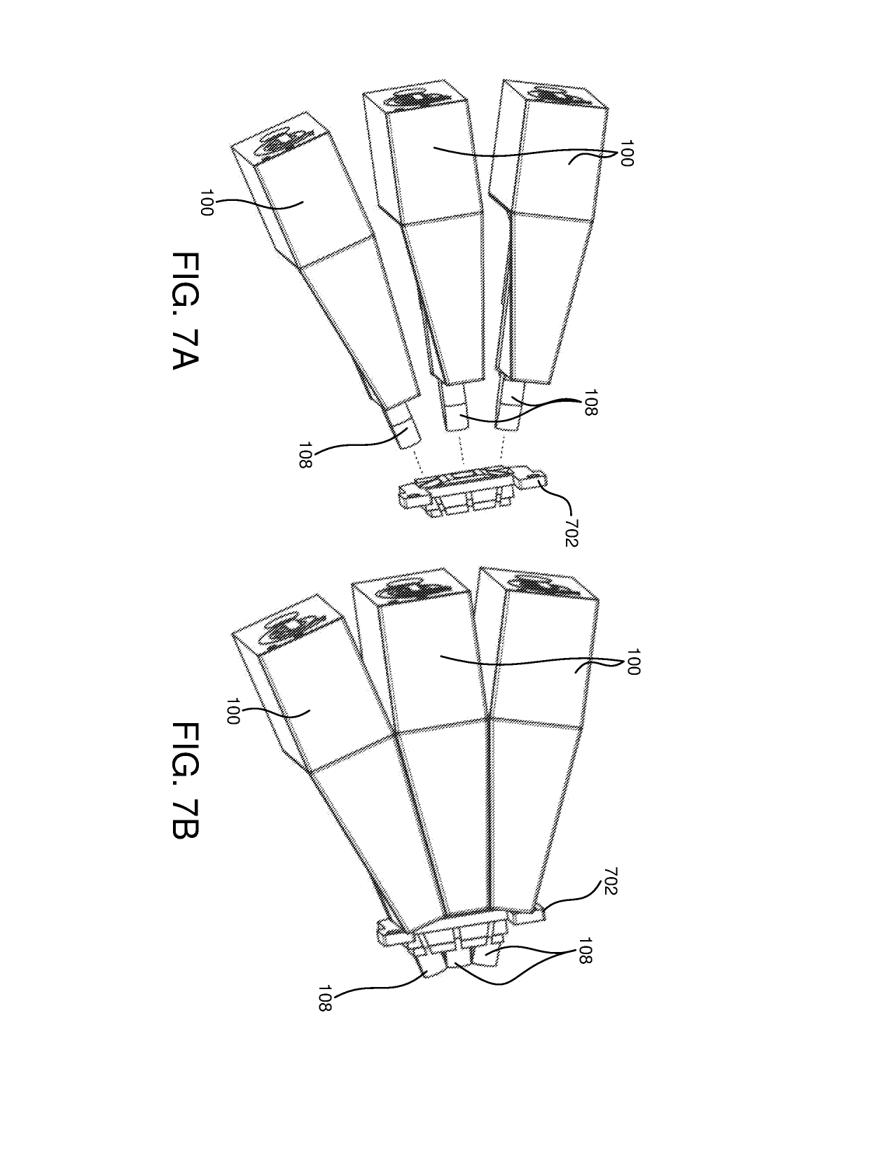

FIG. 7A is a perspective view of three color dispensers 100 and a mounting bracket 702 prior to insertion into the mounting bracket 702, according to various embodiments. FIG. 7B is a perspective view of three color dispensers 100 and a mounting bracket 702 after insertion into the mounting bracket 702, according to various embodiments. In some embodiments, the direct color system is a modification to an existing pellet extruder 3D printer. This is facilitated by the installation of a specialized mounting bracket 702 onto the existing extruder 3D printer. Adapting the 3D printer for the direct color system includes cutting a hole in the side of the 3D printer wall and screwing the mounting bracket 702 onto the 3D printer.

In some embodiments, the mounting bracket 702 uses existing screws and holes. In other embodiments, the mounting bracket 702 is installed using new screw holes. Each of the three (3) color dispensers 100 snap into their respective spot in the mounting bracket 702. In some embodiments, the color dispensers 100 are fully accessible while installed in the mounting bracket 702. In other embodiments, the color dispensers 100 are locked into the mounting bracket 702 and require a tool and/or significant force for removal. In some embodiments, the color dispensers 100 can each be taken in and out of the mounting bracket 702 at will with the use of two hands. In some embodiments, the mounting bracket 702 comes with a template to be used for cutting a hole in the 3D printer for the mounting bracket 702. While three openings for color dispensers 100 are depicted in the mounting bracket 702, other embodiments include more or less openings for color dispensers 100.

Note that the color dispensers 100 are wedge-shaped to fit into the small area of the mounting bracket 702. The wedge shape facilitates an increased size for the hopper 102 and color auger motor 106 while having a nozzle 108 sized to fit into the mounting bracket 702, which is sized to span a chamber within the 3D printer. In some embodiments, the chamber of the 3D printer is a location where pellets are fed into the 3D printer. In some embodiments, the chamber is above where the pellets are heated. In other embodiments, the mounting bracket 702 is located at a chamber of the 3D printer where heating the pellets takes place.

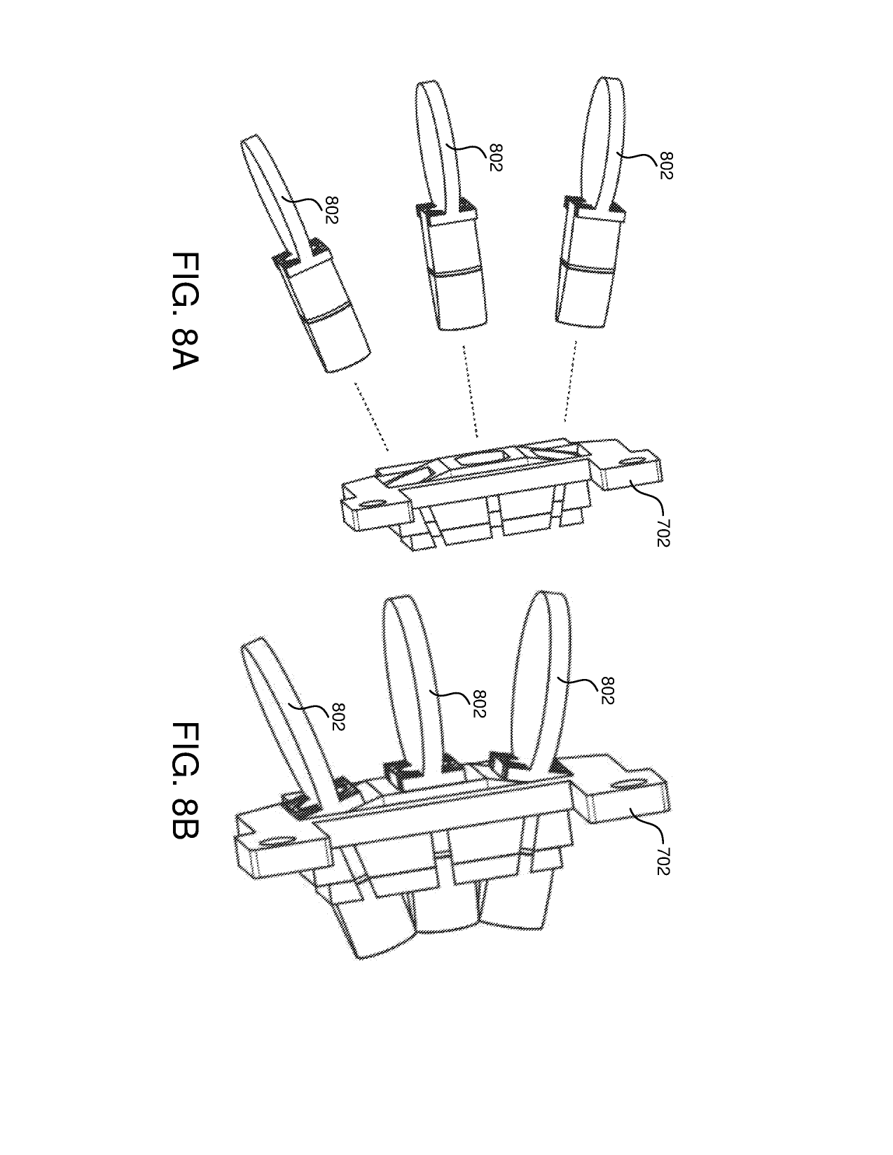

FIG. 8A is a perspective view of a mounting bracket 702 for color dispensers 100 and nozzle plugs 802 for openings in the mounting bracket 702, according to various embodiments. FIG. 8B is a perspective view of the mounting bracket 702 for color dispensers 100 and the nozzle plugs 802 inserted into the openings in the mounting bracket 702, according to various embodiments. The nozzle plugs 802 are configured to seal the openings in the mounting bracket 702 when color dispensers 100 are not inserted.

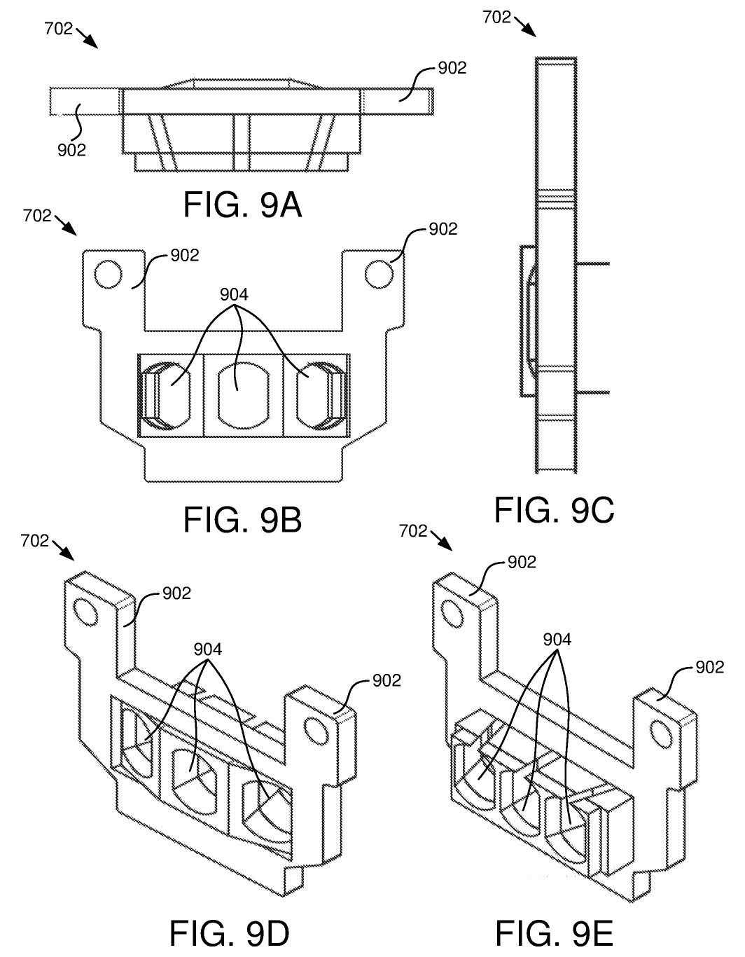

FIG. 9A is a top view, FIG. 9B is a front view, FIG. 9C is a side view, FIG. 9D is a front perspective view, and FIG. 9E is a back perspective view of the mounting bracket 702 of FIG. 8A, according to various embodiments. The mounting bracket 702 includes wings 902 for screw holes to mount to the 3D printer. In some embodiments, the wings 902 are positioned to fit over existing screw holes in the 3D printer. The mounting bracket 702 includes nozzle openings 904 for insertion of the color dispensers 100. Note that the nozzle openings 904 are at appropriate angles so that the wedge-shaped color dispensers 100 are able to fit into the nozzle openings 904.

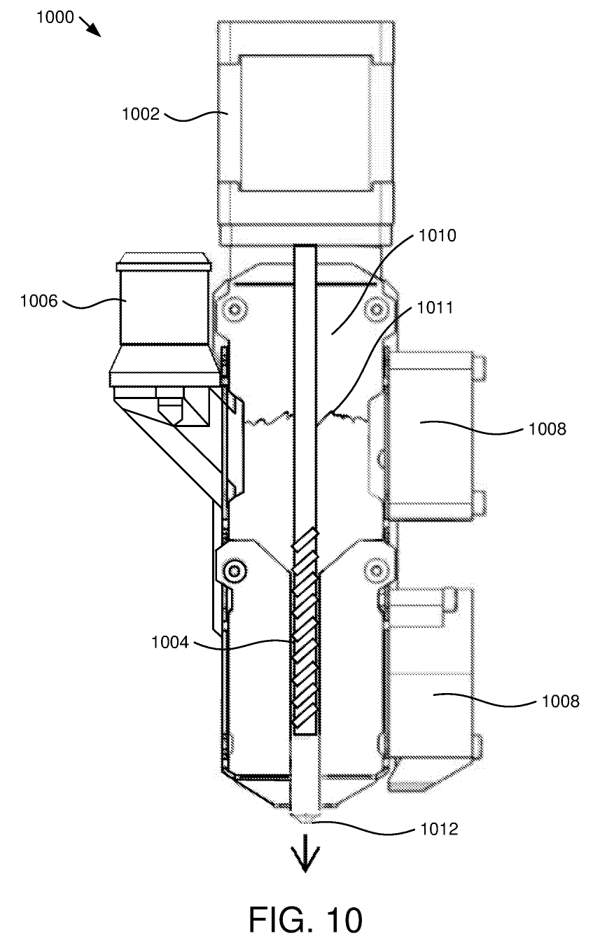

FIG. 10 is a section view of a 3D printer 1000 without color dispensers 100, according to various embodiments. The 3D printer 1000 includes a main auger motor 1002 at the top that powers a main auger 1004 running through the center of the 3D printer 1000. The 3D printer 1000 includes a pellet hopper 1006 configured to feed pellets into a chamber 1010. A level 1011 of pellets is indicated in the chamber 1010. In the 3D printer 1000 depicted in FIG. 10, the chamber 1010 is where the pellets are inserted by the pellet hopper 1006 and then melted by a heat source.

The 3D printer 1000 includes two fans 1008 configured to cool various parts of the 3D printer 1000. In some embodiments, a controller for the 3D printer 1000 controls a heat source and the fans 1008 to maintain temperatures within the 3D printer 1000 at desired levels. A printer nozzle 1012 is at the bottom of the 3D printer 1000 and is where melted material of the pellets is extruded. In some embodiments, the printer nozzle 1012 is designed to facilitate a precise extrusion of plastic or other material. In some embodiments, the 3D printer 1000 includes gears and slides, movable arms, or other means to move the 3D printer 1000 during printing while the main auger 1004 extrudes printing material at a very precise rate and location.

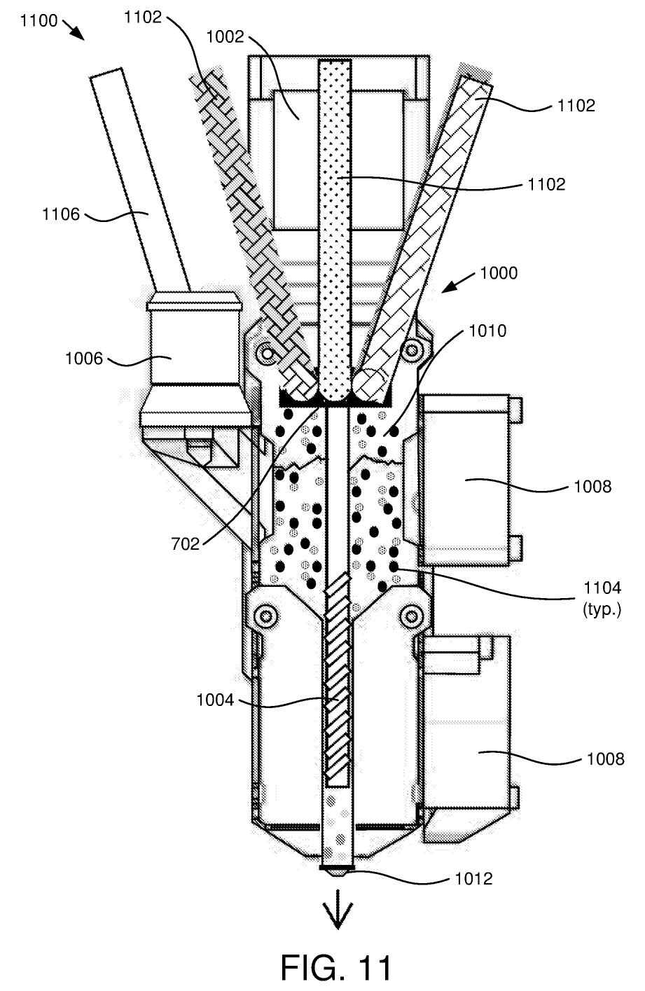

FIG. 11 is a section view 1100 of the 3D printer 1000 of FIG. 10 with color dispensers 100, according to various embodiments. The 3D printer 1000 includes a mounting bracket 702 with a graphical representation 1102 of the color dispensers 100 where three colors are fed into the mounting bracket 702. Each color is represented by a different pattern. Color particles 1104 of various colors are depicted in the chamber 1010. Note that the color particles 1104 are depicted much larger than a powdered substance that would be used in reality. The pellet hopper 1006 also includes a pellet feeding hose 1106 that feeds pellets into the pellet hopper 1006, which may or may not be included with the 3D printer 1000. FIG. 11 is intended to show that color particles 1104 entering from the mounting bracket 702 mix with pellets in the chamber 1010 to create a particular color of printing material that is fed by the main auger 1004 and out the printer nozzle 1012.

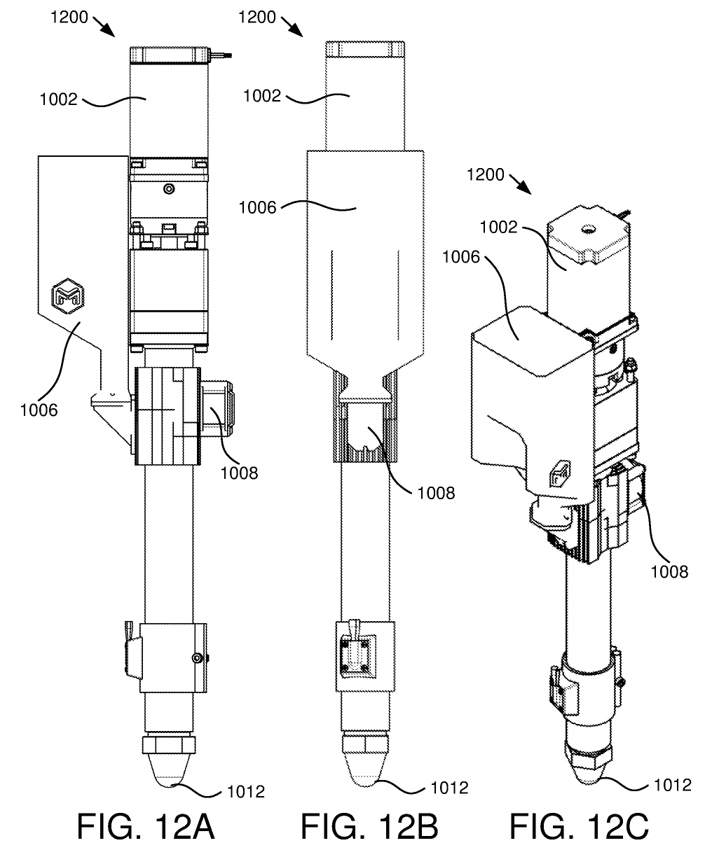

FIG. 12A is a side view, FIG. 12B is a front view, and FIG. 12C is a perspective view of another 3D printer 1200 with a pellet hopper 1006 for 3D printing pellets without color dispensers 100, according to various embodiments. The 3D printer 1200 functions substantially similar to the 3D printer of FIGS. 10 and 11. The 3D printer 1200 includes a main auger motor 1002, a pellet hopper 1006, a fan 1008, and a printer nozzle 1012, which function substantially similar to those described above for FIGS. 10 and 11.

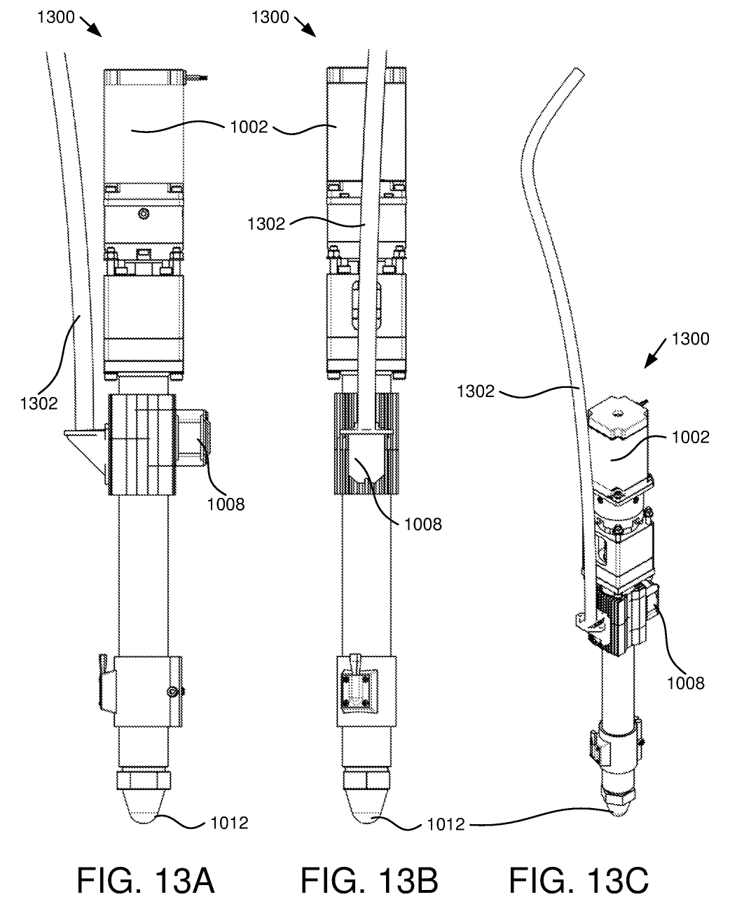

FIG. 13A is a side view, FIG. 13B is a front view, and FIG. 13C is a perspective view of a 3D printer 1300 with a pellet hose feed 1302 and without color dispensers 100, according to various embodiments. The 3D printer 1300 is substantially similar to the 3D printers 1000, 1200 of FIGS. 10, 11, 12A, 12B, 12C described above except with a pellet hose feed 1302.

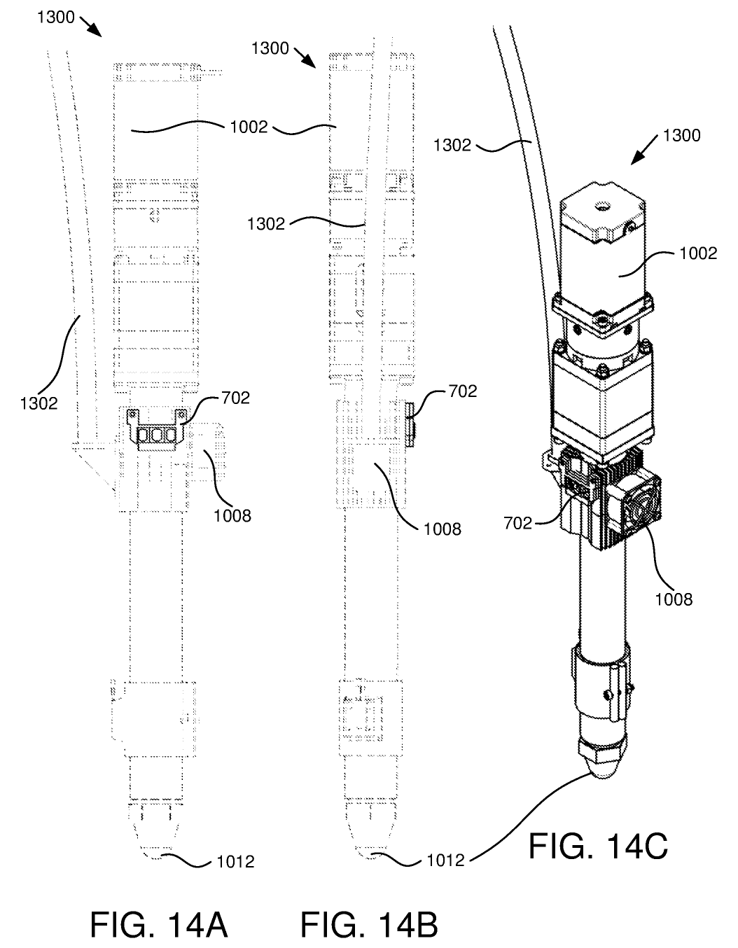

FIG. 14A is a dashed side view, FIG. 14B is a dashed front view, and FIG. 14C is a perspective view of the 3D printer 1300 of FIG. 13A with a mounting bracket 702 for color dispensers 100 without the color dispensers 100 inserted, according to various embodiments. The 3D printer 1300 in FIGS. 14A and 14B are depicted as dashed to emphasize the mounting bracket 702. In the embodiments of FIGS. 14A-14C, the mounting bracket 702 uses existing screws of the 3D printer 1300. In addition, the mounting bracket 702 is mounted just higher than where the pellet hose feed 1302 and associated assembly feed pellets into the 3D printer 1300.

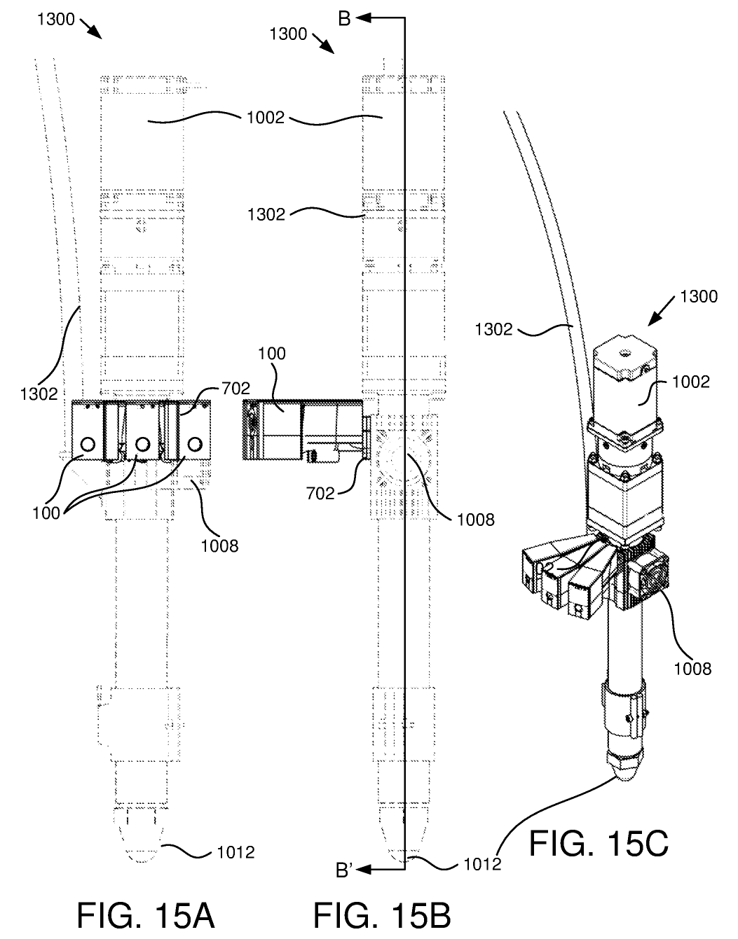

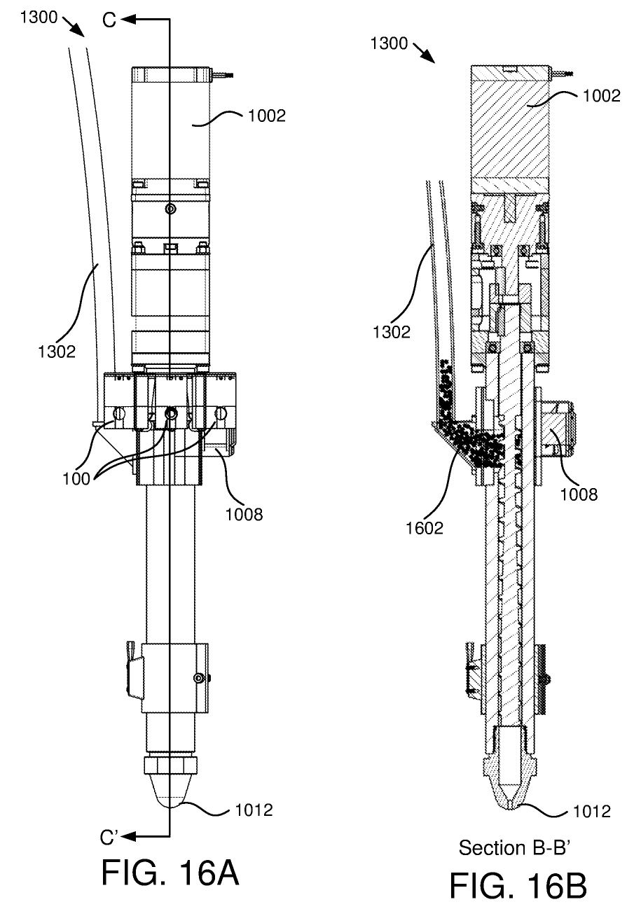

FIG. 15A is a dashed side view, FIG. 15B is a dashed front view, and FIG. 15C is a perspective view of the 3D printer 1300 of FIG. 13A with a mounting bracket 702 for color dispensers 100 with the color dispensers 100 inserted, according to various embodiments. FIG. 16A is a side view and of the 3D printer 1300 of FIG. 13A with a mounting bracket 702 for color dispensers 100 with the color dispensers 100 inserted, according to various embodiments. FIG. 16B is a section view of the 3D printer 1300 of FIG. 16A with a mounting bracket 702 for color dispensers 100 with the color dispensers 100 inserted, according to various embodiments. FIG. 16B depicts pellets 1602 being fed into the 3D printer 1300.

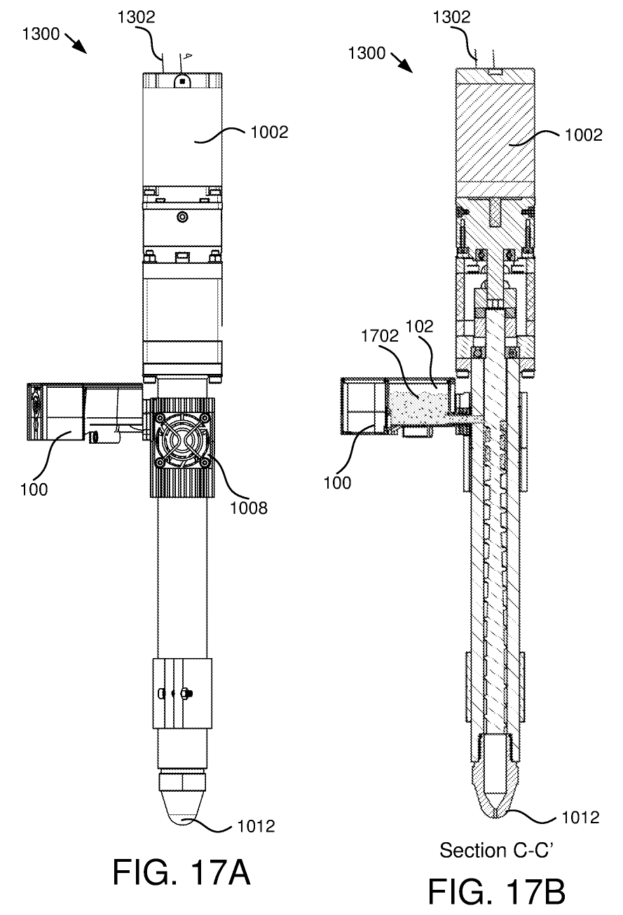

FIG. 17A is a back view and FIG. 17B is a section view of the 3D printer 1300 of FIG. 13A with a mounting bracket 702 and color dispensers 100 inserted into the mounting bracket 702, according to various embodiments. FIG. 17B depicts colorant/additive powder 1702 in the hopper 102 of the color dispenser 100 and being fed out the nozzle 108 to the 3D printer 1300, which is then mixed with the pellets in the 3D printer 1300.

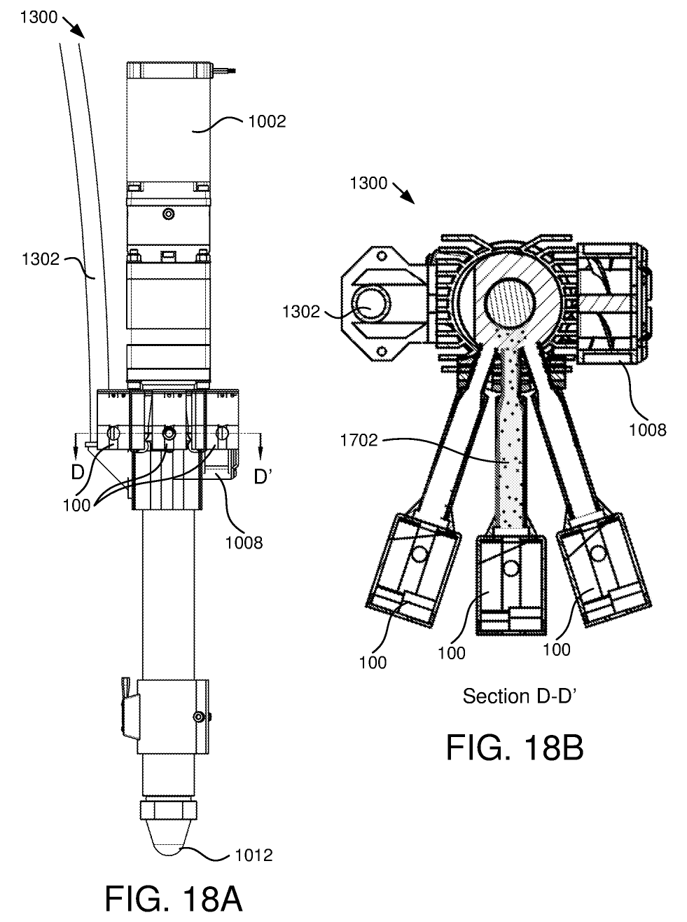

FIG. 18A is a side view of the 3D printer 1300 of FIG. 13A and a section D-D' line and FIG. 18B is a section D-D' view of the 3D printer 1300 of FIG. 18A, according to various embodiments. FIG. 18B depicts colorant/additive powder 1702 being fed into the 3D printer 1300.

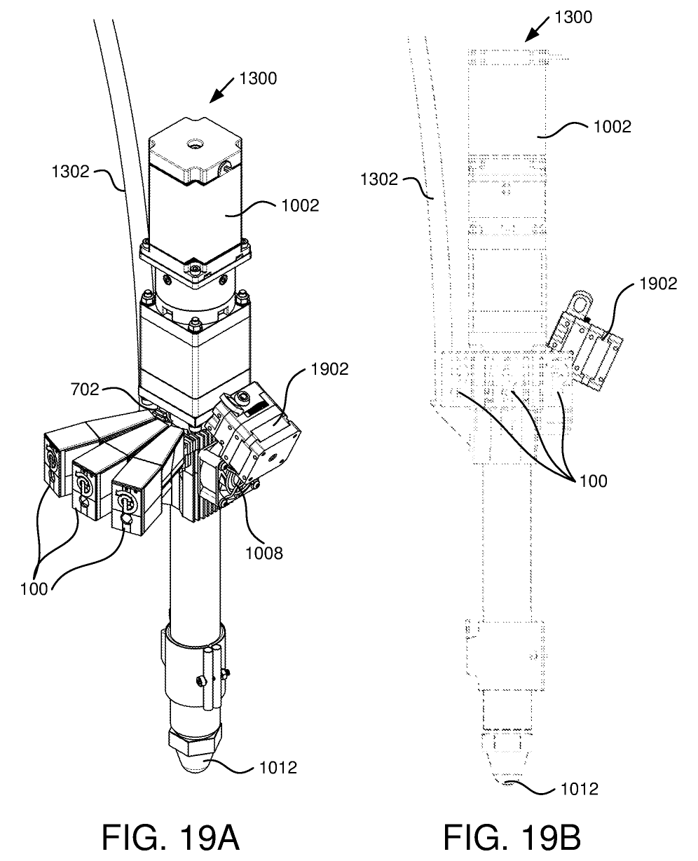

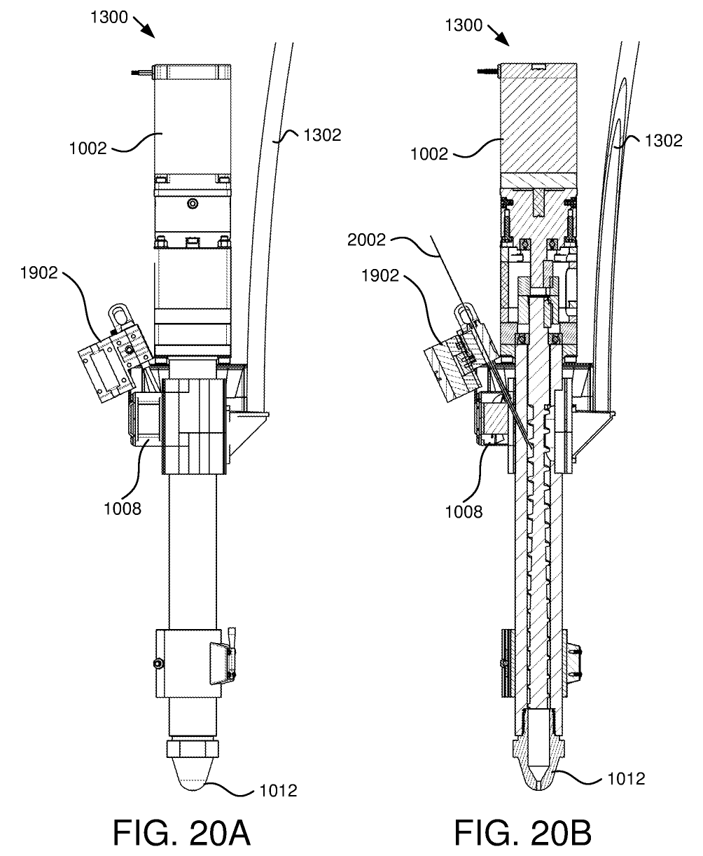

FIG. 19A is a perspective view of a 3D printer 1300 with a pellet hose feed 1302, a mounting bracket 702 and three color dispensers 100 and a filament feeder 1902, according to various embodiments. FIG. 19B is a dashed side view of the 3D printer 1300 of FIG. 19A with a pellet hose feed 1302, a mounting bracket 702 and three color dispensers 100 and a non-dashed view of the filament feeder 1902, according to various embodiments. FIG. 20A is an opposite side view of the 3D printer 1300 of FIG. 19A with a pellet hose feed 1302, a mounting bracket 702 and three color dispensers 100 and the filament feeder 1902 and FIG. 20B is a section view of the 3D printer 1300 of FIG. 20A, according to various embodiments. The filament feeder 1902 feeds a filament used for 3D printing. In some embodiments, the filament feeder 1902 feeds a filament. In other embodiments, the filament feeder 1902 feeds a filament that is an ABS filament, a PLA filament, a PETG filament, a polycarbonate ("PC") filament, a nylon filament, a carbon fiber-filled filament, a poly ether etherketone ("PEEK") filament, or the like.

FIG. 20B depicts a filament 2002 being fed into the filament feeder 1902 and into the heat chamber of the 3D printer 1300. The filament feeder 1902 feeds conventional filament stock directly into a melt chamber of the 3D printer 1300 which eliminates the need to own a filament-based 3D printer. The filament is directed toward and is grabbed by the main auger 1004 and pulled in and melted at an appropriate rate. The filament is then melted and extruded in a similar fashion to pellets.

The filament feeder 1902, in some embodiments, mounts to a free side of the 3D printer 1300 with a simple filament mounting bracket. In some embodiments, the 3D printer 1300 includes a National Electrical Manufacturers Association ("NEMA") 17 main auger motor 1002 with a dual metal gear drive. The main auger motor 1002, in some embodiments, is connected to a direct color controller via a standard 4-wire cable for NEMA motors. In some embodiments, the filament feeder 1902 comes with a template used to drill into the 3D printer a hole that aligns with the filament feeder 1902.

In some embodiments, controls for the optional filament feeder 1902 are accomplished and the filament feeder 1902 may include a filament motor driving a roller to feed the filament at a prescribed rate, which will result in the first multi-purpose auger-based extruder that can not only handle pellets and filament stock, but can effectively print them both at the same time. In some embodiments, the roller includes protrusions, ridges, or the like to grasp the filament. In other embodiments, the filament feeder 1902 includes two or more rollers configured to grasp and feed the filament. The filament feeder 1902, in some cases, may be also delivered at a low price suitable for common home workshop use. In some embodiments, the user simply needs to enable and select the filament feeder 1902 in a graphical user interface for the direct color system software in order to print with the filament feeder 1902 option.

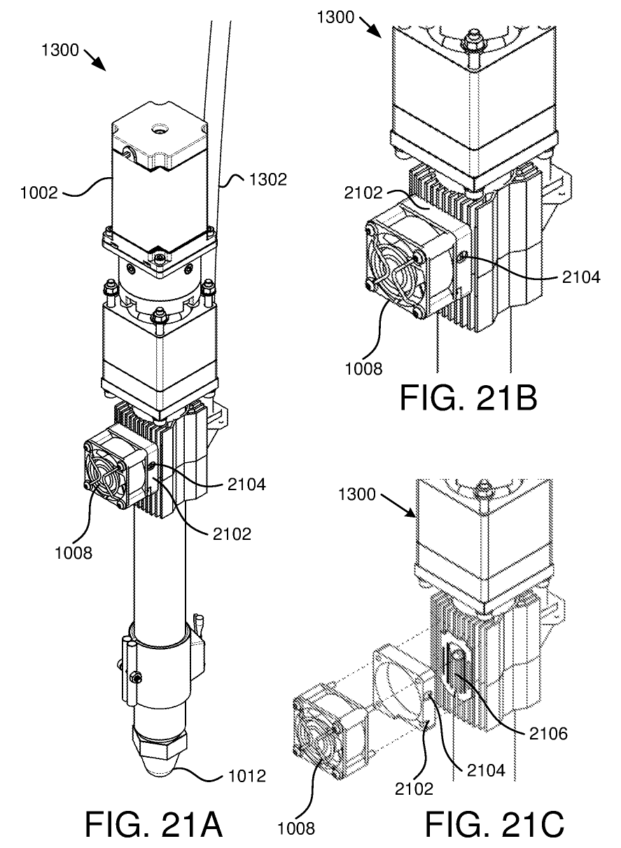

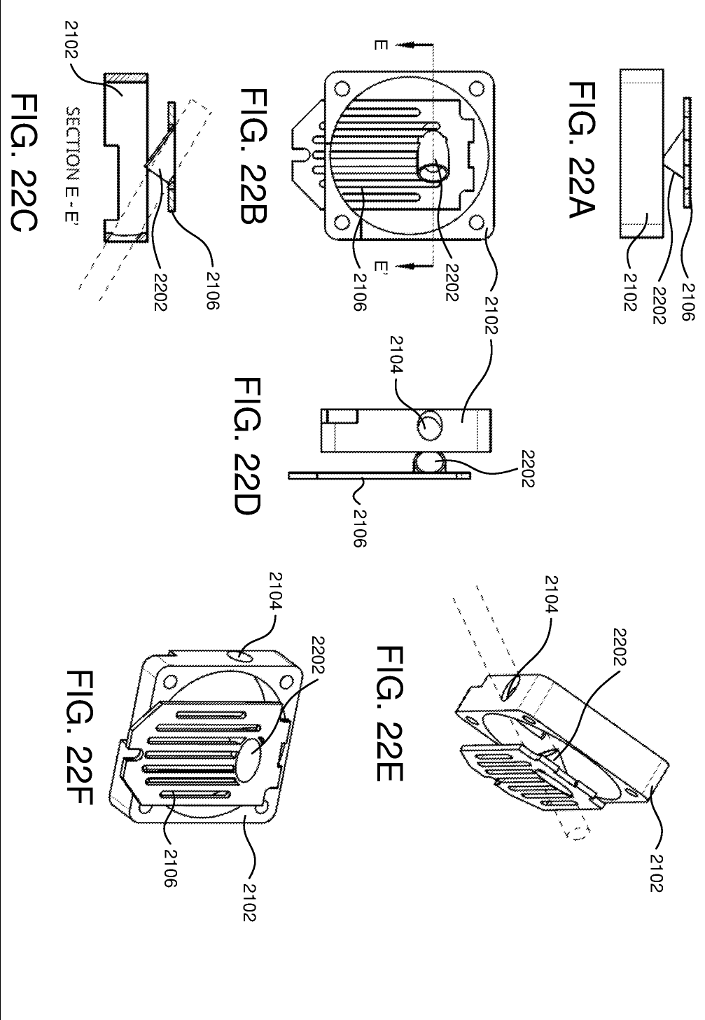

FIG. 21A is a perspective view of the 3D printer 1300 of FIG. 13A with a spacer bracket 2102 between a fan 1008 and the 3D printer 1300 where the spacer bracket 2102 is configured for a camera, according to various embodiments. FIG. 21B is a closeup perspective view of the fan 1008, spacer bracket 2102, and 3D printer 1300 of FIG. 21A, and FIG. 21C is a closeup exploded perspective view of the fan 1008, spacer bracket 2102, and 3D printer 1300 of FIG. 21A, according to various embodiments. The spacer bracket 2102 provides an opening into the chamber of the 3D printer 1300 where pellets and colorant are added.

In the embodiments with the spacer bracket 2102, a pin-hole type camera or other type of camera is located inside the melt chamber of the 3D printer 1300 and provides real-time monitoring of colorant addition, material flow and mixing at the melt zone. In some embodiments, the design incorporates, as an added feature, artificial intelligence (AI) to build a color model for error detection. Error detection modes would be for spotting an empty hopper 102, as well as failure to feed colorant, verification of feed-screw color auger 104 rotation and direction of rotation.

In some embodiments, the direct color system with a camera would be able to identify the errors visually through training the color model. The error detection visually compares a library of images which are error free to the current state continually. In some embodiments, the real time monitoring of the camera's video feed is displayed on a user interface which also includes a controls interface for operating the direct color system as described herein. In some embodiments, an alarm and notification could be generated upon detection of an error. In some embodiments, the camera connects to the direct color system microcontroller via a cable. In some embodiments, the cable is a universal serial bus ("USB") cable, which is a standard commodity product. In other embodiments, the cable is a different type. In some embodiments, a camera feed is automatically displayed in Octoprint for the user to view the video in real time.

As depicted in FIGS. 21A-21C, the camera is mounted at a fan 1008 using a spacer bracket 2102. The spacer bracket 2102 is a custom made cooling fan mount that allows the pin-hole camera or other camera, such as a fiber optic camera, to be installed. This cooling fan spacer bracket 2102 is positioned in between the fan 1008 and the housing of the 3D printer 1300. In some embodiments, the spacer bracket 2102 utilizes existing holes and screws. FIG. 21C depicts the fan 1008, spacer bracket 2102 with a camera hole 2104, and a vent panel 2106 that are assembled in FIG. 21B.

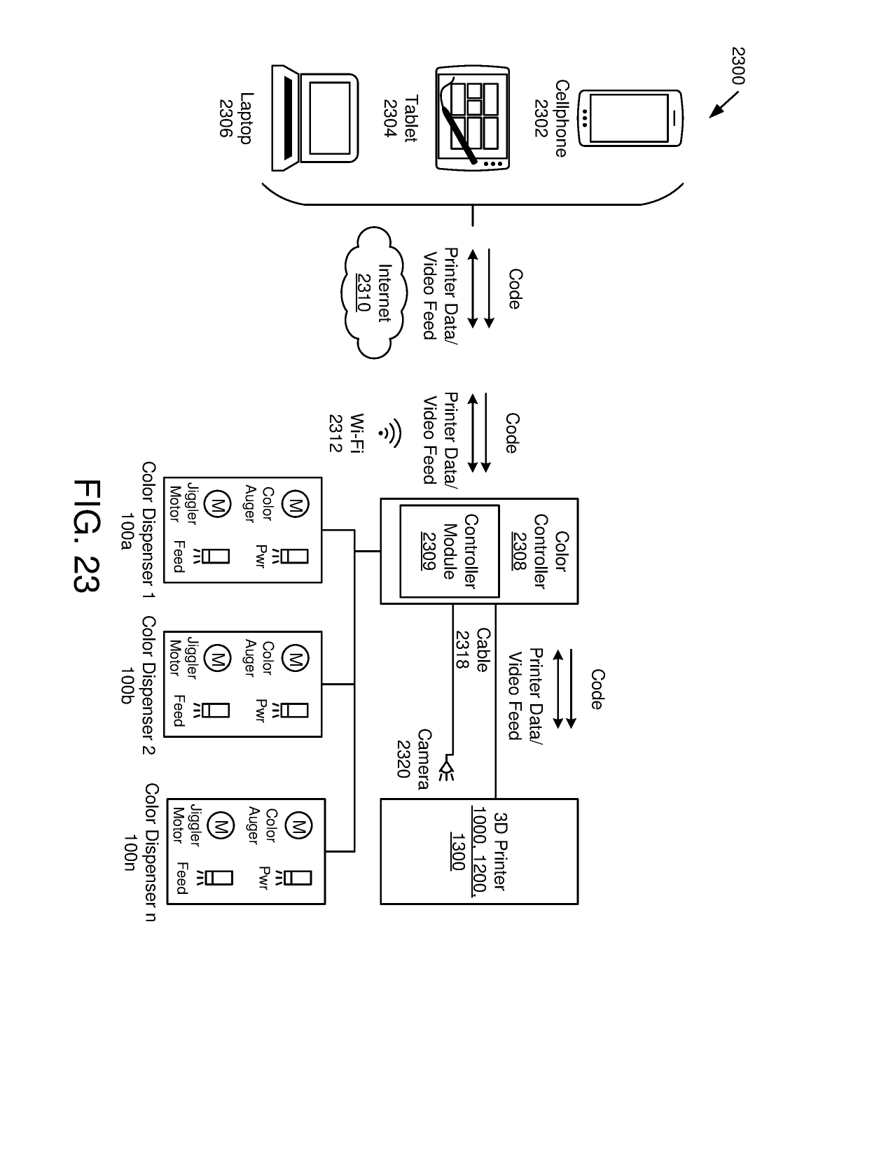

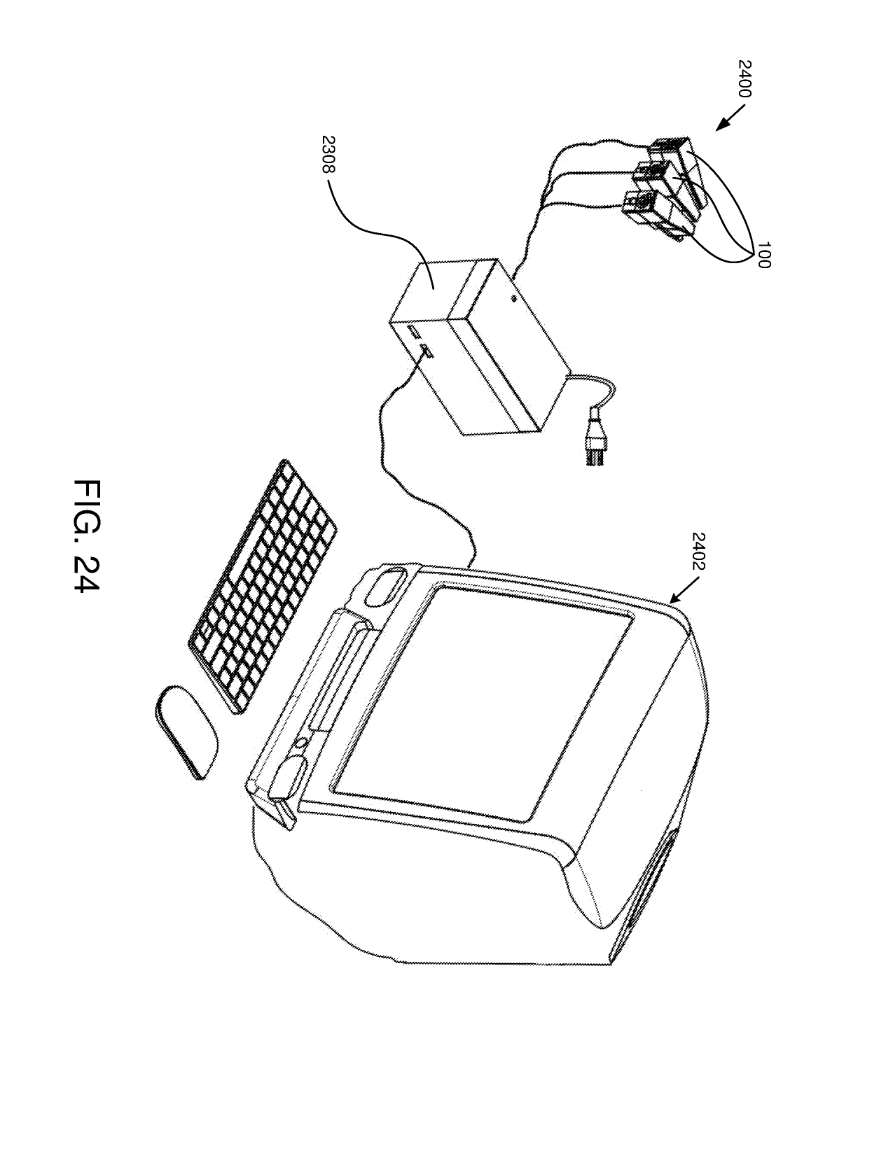

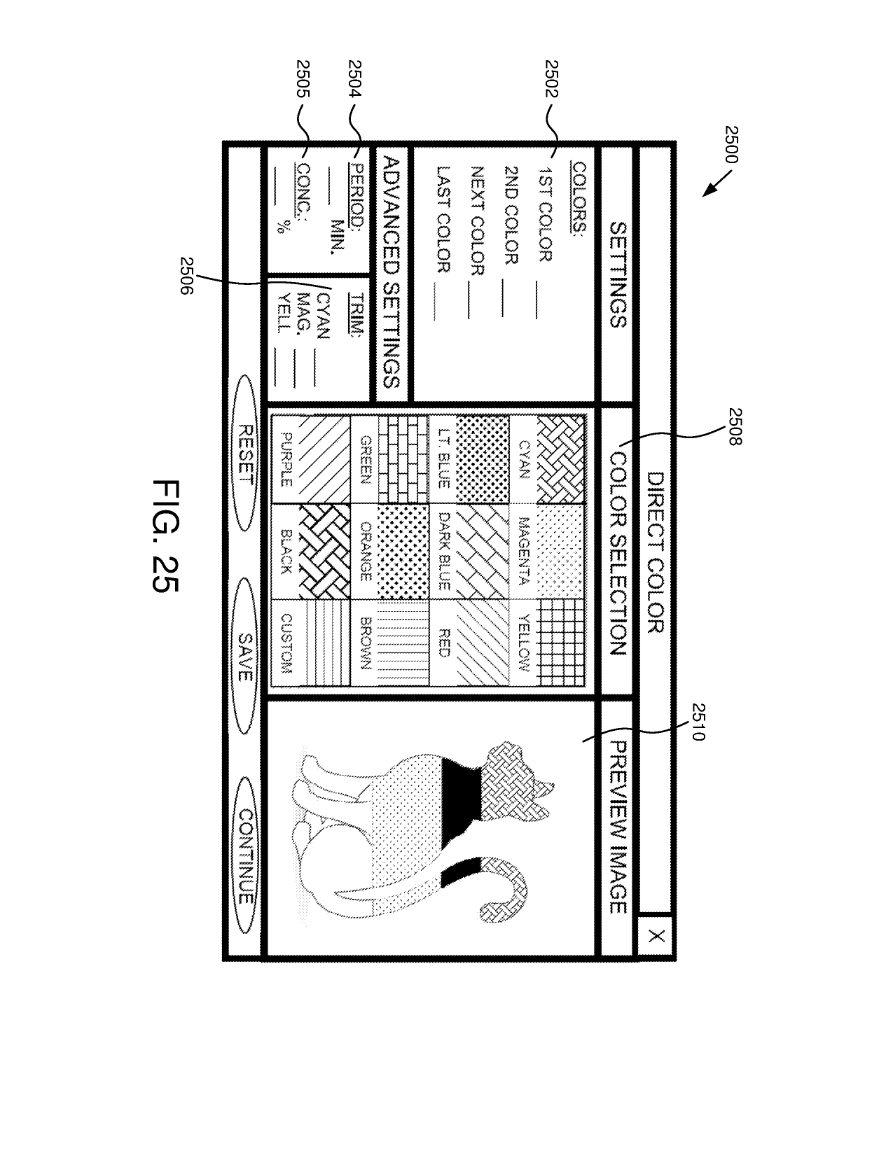

FIG. 22A is a top view of the spacer bracket 2102 of FIG. 21A and vent panel 2106 of the 3D printer 1300, according to various embodiments. FIG. 22B is front view of the spacer bracket 2102 and the vent panel 2106 of the 3D printer 1300 behind the spacer bracket 2102 of FIG. 21A, and FIG. 22C is a section E-E' view of the spacer bracket 2102 of FIG. 21A, according to various embodiments. FIG. 22D is a side view of the spacer bracket 2102 of FIG. 21A and the vent panel 2106 of the 3D printer 1300, according to various embodiments. FIG. 22E is a back perspective view of the spacer bracket 2102 of FIG. 21A and the vent panel 2106 of the 3D printer 1300 and FIG. 22F is another back perspective view of the spacer bracket 2102 of FIG. 21A and the vent panel 2106 of the 3D printer 1300, according to various embodiments.

Typically, there is a vent panel 2106 that is also an integral part of the cooling fan 1008 and melt chamber cooling system. In some embodiments, this vent panel 2106 is custom made to accommodate the pin-hole camera. The spacer bracket 2102 and vent panel 2106, in some embodiments, are designed to fit together and align when installed, allowing the pin-hole camera to fit through both and into the melt chamber. In other embodiments, a standard vent panel 2106 is modified or drilled to accommodate the camera. In some embodiments, the vent panel 2106 is attached to the 3D printer 1300 by the existing holes and longer screws. This arrangement of the spacer bracket 2102 and vent panel 2106 is designed to allow air to move through into the melting chamber to provide cooling. FIGS. 22A-22F include a camera bracket 2202 on the vent panel 2106 to hold the camera. The camera may be a pinhole camera, an optical fiber camera, or any other type of camera that fits in the camera hole 2104, camera bracket 2202, and vent panel 2106.

FIG. 23 is a schematic block diagram of a direct color system 2300 of a 3D printer 1000, 1200, 1300 with three color dispensers 100, according to various embodiments. FIG. 24 is a perspective view 2400 of the system of FIG. 23 with a connecting device being a computer 2402 directly wired to a color controller 2308, according to various embodiments. The direct color system 2300 includes a connecting device, such as a mobile phone 2302, a tablet computer 2304, a laptop computer 2306, or other computing device (e.g., computer 2402). The connecting device is connected to a color controller 2308 over the internet 2310, a Wi-Fi connection 2312, a wired connection, as depicted in FIG. 24, or other network. While the internet 2310 and a Wi-Fi connection 2312 are depicted, one of skill in the art will recognize that the connecting device may be connected via a single connection, such as a Wi-Fi connection 2312, a BLUETOOTH® connection, a wired connection, or the like without the internet 2310. In other embodiments, the connecting device is connected to the color controller 2308 via two or more network connections.

The color controller 2308, in various embodiments, is configured to control the color auger motors 106, the vibrating motors 206, the power light 202, the feed light 203, etc. In some embodiments, the color controller 2308 interfaces with controls of the 3D printer 1000, 1200, 1300. In some examples, the color controller 2308 integrates with software of the 3D printer 1000, 1200, 1300 to provide color options during printing of an object. One of skill in the art will recognize other functions of the color controller 2308.

In various embodiments, the connecting devices are configured to provide code to the color controller 2308. Once the code is installed in the color controller 2308, the connecting devices communicate with the color controller 2308 in terms of printer data, a video feed, and the like.

The color controller 2308, in some embodiments, includes one or more of a microprocessor, memory, non-volatile data storage, a network interface card ("NIC"), a peripheral component interconnect express ("PCIe") card, or the like. In other embodiments, the color controller 2308 includes a programmable hardware device, such as an FPGA, a PLA, or the like. In some embodiments, the color controller 2308 includes motor controllers. In other embodiments, all or a portion of the color controller 2308 is implemented using hardware circuits. One of skill in the art will recognize various way to implement the functions of the color controller 2308.

In some embodiments, the color controller 2308 includes a controller module 2309 configured to signal each color auger motor 106 to rotate to deliver a prescribed amount of powdered substance (colorant, color powder, additive, etc.) to the chamber of the 3D printer 1000, 1200, 1300, where the main auger 1004 of the 3D printer 1000, 1200, 1300 mixes the powdered substance with printing material to color the printing material. In some embodiments, the controller module 2309 is configured to combine the powdered substance from two or more color dispensers 100 to provide a printing material colored using a mixture of the powdered substance from the two or more color dispensers 100. In some embodiments, there are at least three color dispensers 100 with a cyan color powder, a magenta color powder, and a yellow color powder and the controller module 2309 is configured to mix the cyan color powder, the magenta color powder, and the yellow color powder to achieve a desired color from a CMY color scheme.

In some embodiments, the controller module 2309 directs the color dispensers 100 to periodically dispense a powdered substance. In some embodiments, the controller module 2309 directs the color dispensers 100 to dispense powdered substance maybe four or five seconds every 5 minutes of printing. In other embodiments, the controller module 2309 dispenses powdered substance at a faster rate with less powdered substance or dispenses powdered substance at a slower rate with more powdered substance being dispensed.

In some embodiments, the controller module 2309 is configured to interface with executable code of the 3D printer 1000, 1200, 1300 and the controller module 2309 provides a graphical user interface ("GUI") that includes fields configured to be modified by a user to program color information for various parts of an object being printed. In embodiments with a filament feeder 1902 with a filament motor, the controller module 2309 is configured to rotate a roller to feed the filament into the chamber of the 3D printer 1000, 1200, 1300.

The color controller 2308 is connected to each color dispenser 100 where the direct color system 2300 includes N color dispensers 100a-100n. In some embodiments, the direct color system 2300 includes a camera 2320 connected with a cable 2318 to the color controller 2308 where the camera is mounted as described above with respect to FIGS. 21A-21C and 22A-22F.

In some embodiments, control of the direct color system 2300 and 3D print job integration is possible with two general modes: a stand-alone mode or via WebUI and slicer software. WebUI is a tool that allows interaction with websites using artificial intelligence ("AI") agents and supports various large language models ("LLMs"). Slicer software is configured to operate with 3D printers.

In WebUI/Slicer mode the 3D printer 1000, 1200, 1300 is controlled directly by the direct color system 2300 and the colorant/additive dispensing is directly integrated with the print job as one so the direct color system 2300 is operating in unison with the 3D printer 1000, 1200, 1300. Colorant/additive dispensing is automatically triggered and at the beginning of the print job and terminated at the end of the print job. The 3D printer 1000, 1200, 1300 and the direct color system 2300 operate as one, performing both functions as a single operation.

In order for this to occur, in some embodiments, a master/slave communication software protocol is flashed to the microprocessor of the color controller 2308 and to the 3D printer's on-board microcontroller. Klipper® is a widespread, globally available, open-source software package is used for this master/slave communication with 3D printers. Klipper is currently free and is designed specifically for 3D printers and for this master/slave communication with 3D printers. When Klipper is included, Klipper is installed on the microcontroller in the color controller 2308 and the microprocessor of the 3D printer 1000, 1200, 1300, which allows the 3D printer's control board and hardware (motors, heaters, display/touchscreen, memory, etc.) to be fully controlled by the color controller 2308. Thus, the microcontroller in the direct color system 2300 acts as the master.

In addition to Klipper, the microcontroller of the color controller 2308 also may include a WebUI hosting capability provided by software installed on the color controller 2308. In some embodiments, Octoprint^{TM} software is utilized as a WebUI host. With this Octoprint implementation, full control of the 3D printer 1000, 1200, 1300 (and integrated direct color system 2300) is available on wireless devices so print jobs can be set up and started, stopped, monitored, and altered in real time from anywhere with a mobile phone 2302, a tablet computer 2304 or a laptop computer 2306 through the internet 2310. Once configured, all connections between the 3D printer 1000, 1200, 1300, direct color system 2300, and the external device can be wireless over a Wi-Fi network 2312 or with a cable, such as a USB cable.

Using slicer software, 3D print jobs utilize the slicer software to configure G-code (e.g., geometric code) to control the 3D printer 1000, 1200, 1300. This G-code is an interpretation of a three- dimensional object broken down layer by layer and converted into machine code to be executed by the 3D printer 1000, 1200, 1300. PrusaSlicer^{TM} from PRUSA Research® is a widespread, globally available, open-source software package is used for configuring G-code. PrusaSlicer currently is free and is designed specifically for 3D printers and for configuring G-code.

In order to first generate the 3D print file (G-code) that Octoprint will send and start, PrusaSlicer or similar is used. The user will be able to select colors and color changes at user defined times during the print job by selecting the colors and duration for each color directly in the 3D slicing software via a custom software plugin. The direct color system GUI (as described in more detail below with reference to FIG. 25), in some embodiments, is in the form of a software plug-in which works inside of PrusaSlicer. The GUI plug-in, in some embodiments, is run after a 3D model has already been sliced and the duration of the print has been automatically calculated. The GUI then allows the user to graphically select what colors they want to 3D print with as well as graphically selecting at what heights along the z-axis the color changes are to take place during a print job.

In some embodiments, other optional user inputs available in the GUI are the adjustable time delay between powder feeds, the percentage of colorant to be dispensed, and calibration factors for the three color dispensers 100. PrusaSlicer then takes the users input from the direct color plug-in and calculates and compiles a final print job G-code file. This G-code file can then be used in Octoprint to send and start the print job as described above.

In some embodiments, an additional feature the user can specify to use is to pause the print job before each color change or run continuously without pausing the extrusion upon color changes. Pausing in between color changes is not required, but if desired allows for the user to fully purge out the melt chamber and extruder barrel prior to commencing the next color. This purge process will be assisted by a subroutine which temporarily moves the printhead away from the print subject in order to expel (purge) unwanted material from the extruder into a pile off to the side to be discarded. In some embodiments, this function would prompt the user for purge duration and if "purge again?" or "resume printing?" options.

In instances where there is no purging, in some embodiments, a purge delay is calculated which is the time between when colorant is added by the color dispensers 100 and when the new color is dispensed. The purge delay is then factored into the timing of the new color. For example, the purge delay may be 3 minutes. In this example, the direct color system 2300 calls for a powdered substance to be added 3 minutes before the time that the printing material with the new color is to be output by the 3D printer 1000, 1200, 1300. In other embodiments, the purge delay is factored in the purge process. For example, while purging, the direct color system 2300 calls for the powdered substance to be added 3 minutes before the time that the purge ends and printing the new color begins.

Color changes take place rapidly with this direct color system 2300 due to the close proximity of the colorant addition to the point of extrusion. To achieve effective color changes without pausing the print job and purging the entire hopper and barrel of raw plastic. To successfully utilize this method, in some embodiments, the direct color system 2300 changes colors in the direction of from clear to black (lighter to darker) throughout the duration of the print job. In other embodiments, color changes from darker to lighter are used. However, color changes from darker to lighter are typically not as clean. In other embodiments, each color change is preceded by a purge.

For a stand-alone mode, the microcontroller of the color controller 2308 issues commands to the direct color system 2300 generated in response to user input at the interface. The user interfaces with a textual or graphically based input method on a digital device with a screen, such as a laptop computer 2306, mobile phone 2302 or tablet computer 2304 via touch screen, keyboard or mouse. The graphical interface consists of a menu prompting the user to select the colors they wish to 3D print with.

In some embodiments, once colors are entered the user is then asked to input the duration of the print job in minutes prior to the start of the print. Based on the user's input of colors and print times, the proprietary algorithm calculates the proportions of colorant to dispense throughout the duration of the project and not longer. In some embodiments, between 20 and 40 pre-defined color options are provided in the software, however the user can create a custom color from one of many thousands of CMY combinations. Upon a command for a colorant to be dispensed, the motor rotates the color auger 104 and the vibrating motor 206 activates in order to move and advance colorant powder through the feed-screw barrel 210 of the color dispenser 100 and out into the melt chamber of the 3D printer 1000, 1200, 1300.

In stand-alone operation the direct color system 2300 does not communicate with the 3D printer controls. In stand-alone mode the direct color system 2300 is only physically connected to the 3D printer 1000, 1200, 1300 where the color dispensers 100 attach to the 3D printer 1000, 1200, 1300 via the mounting bracket 702. In the stand-alone mode the direct color system 2300 is not electronically connected to the 3D printer 1000, 1200, 1300. In stand-alone mode the microcontroller of the color controller 2308 is controlled by a wired connection via USB cable or other cable connected to a mobile phone 2302, tablet computer 2304 or laptop computer 2306. In some embodiments, the wired connection uses a basic serial communication. In other embodiments, in stand-alone mode the microcontroller of the color controller 2308 is controlled via a wireless connection.

In the stand-alone mode the control of the colorant/additive dispensing is achieved by user interaction with a menu, providing input when prompted for a print job duration, color durations, and raw material flow. User interaction is done with a serial monitor (a.k.a. text window) and keyboard, or a graphical interface utilizing a mouse or touchscreen for input. Alternatively, a Wi-Fi connection 2312 can be used in place of the USB cable to link the microcontroller of the color controller 2308 to the connecting device through a wireless network. Since there is no communication between the direct color system 2300 and the 3D printer 1000, 1200, 1300 in stand-alone mode, the direct color system 2300 feeding is manually started at the same time that the 3D printer 1000, 1200, 1300 begins the print job, and the dispensing of different colors is carried out by a direct color algorithm based on the predetermined intervals (time markers) and colors provided by the user prior to the start of the print job.

Slicer software, such as PrusaSlicer, is used to prepare the 3D print job for stand-alone usage of the direct color system 2300. In this case there is no need to install or utilize the direct color system 2300 PrusaSlicer software plug-in to slice the model and generate the G-code. The model would simply be sliced as usual without the plug-in. Inserting pauses in the G-code for stand-alone mode is not made possible.

In some embodiments, the Slicer/WebUI mode uses a main direct color algorithm, which is based on layer number. The G-code generated by the slicer software dictates; what colorants/additives to dispense, how much to dispense and when to dispense based on the actual layer height along the z-axis that the colors need to change during the print job. User defined colors, layer numbers and any other optional setting inputs are requested and read in via the user interface. Based on the user input of color(s) and layer heights of color changes, the proprietary direct color algorithm calculates the proportions of colorant to dispense throughout the duration of the project.

In some embodiments, the direct color system 2300 precisely delivers fine amounts of the three or more colorants each in measured amounts in exact proportion to and at the correct rate to color the pellets that are being processed through the 3D printer 1000, 1200, 1300. Colorant powder is typically added at a concentration of between 1% and 3% of the raw material being processed by weight. In other embodiments, colorant powder is added at a higher or lower concentration, such as between 0.5% and 5%.

The direct color algorithm is also fundamentally based on flow rate of the raw plastic material. The direct color algorithm assumes a default value however, it is an option to user define a different value. The direct color algorithm calculates the amount of colorant or additive powder by weight that each of the three dispensers must dispense to achieve an amount equivalent to between about 1% and 3% of the raw pellet material flow. The concentration percentage is adjustable by optional user input, but otherwise reverts to a default value.

Adjusting the concentration percentage can lead to variations in translucency and opacity of the finished printed product as desired. Layer values for each color change z-axis height are determined by user input during the slicing of the 3D model in the slicer software. In some embodiments, once the predetermined layer value is met, the direct color algorithm's calculations are set for the next color and colorant/additive powder then begins feeding at a default time period of every 5 minutes, which continues until the next layer value is met corresponding to the next color change. In other embodiments, the default time period is changed to longer or shorter than 5 minutes.

The periodic interval is adjustable by the user as an optional input through the GUI. In some embodiments, an additional optional user defined input is a trim factor for calibrating each of the three color dispensers 100 individually as a means of fine tuning and for user preference. All of these factors are used by the direct color algorithm to calculate the sequences, period, duration of operation of; the lights (power light 202 and feed light 203), the color auger motor 106 and vibrating motor 206 for all three color dispensers 100.

In some embodiments, the Stand Alone mode utilizes the same primary direct color algorithm as the Slicer/WebUI mode. However, the direct color algorithm runs separately in parallel with the operation of the 3D printer 1000, 1200, 1300 while the 3D printer 1000, 1200, 1300 is executing the print job. Also, unlike the WebUI mode, which is based on z-axis layer height, the stand- alone mode direct color algorithm is based on the duration of the print job with time marker(s). In this fashion the color changes correspond to specific points in time throughout the duration of the print job as opposed to layer numbers/height along the z-axis.

This direct color algorithm, in some embodiments, provides feedback to the user via the GUI during the print job. The direct color algorithm reports; total duration, current color, percent completion, and "end of job" in the GUI. User defined colors, print times and any other optional setting input are requested and read in via the user interface. In some embodiments, based on the user's input of color(s) and print time(s) of colors, the proprietary direct color algorithm calculates the proportions of colorant to dispense throughout the duration of the project.

The direct color system 2300 precisely delivers fine amounts of the three colorants each in measured amounts in exact proportion to and at the correct rate to color the plastic that is being processed through the extruder. Colorant powder is typically added at the concentration of between 1% and 3% of the raw material being processed by weight. The direct color algorithm is also fundamentally based on flow rate of the raw plastic material. The direct color algorithm, in some embodiments, assumes a default value however, it is an option to user define a different value.

In some embodiments, the direct color algorithm calculates an amount of colorant or additive powder by weight that each of the three dispensers are to dispense to achieve an amount equivalent to between 1% and 3% of the raw plastic material flow. This concentration percentage is adjustable by optional user input, but in some embodiments otherwise reverts to a default value. Adjusting the concentration percentage can lend to variations in translucency and opacity of the finished product as desired.

In some embodiments, layer values for each color change z-axis height are determined by user input during the slicing of the 3D model in the slicer software. Once the predetermined time marker value is met, the algorithm's calculations are set for the next color and colorant/additive powder then begins feeding at a default time period of every 5 minutes or other time period until the next layer value is met. This periodic interval, in some embodiments, is adjustable by the user as an optional input through the GUI. An additional optional user defined input is a trim factor for calibrating each of the three color dispensers 100 individually as a means of fine tuning and for user preference. All of the factors listed above are used by the direct color algorithm to calculate the sequences, period, duration of operation of; the lights (power light 202 and feed light 203), the color auger motor 106, and the vibrating motor 206 for all three color dispensers 100.

Note that the direct color algorithm described above, in some embodiments, is implemented using executable code stored in non-transitory computer readable media. In other embodiments, the direct color algorithm is implemented using a programmable hardware device. In other embodiments, all or a portion of the direct color algorithm is implemented using hardware circuits. The direct color algorithm includes the controller module along with other features described herein.

While the direct color system 2300 is described with a color controller 2308 separate from the 3D printer 1000, 1200, 1300, in other embodiments, the direct color system 2300 includes the functions of the color controller 2308 implemented directly in the hardware and software of the 3D printer 1000, 1200, 1300.

Beneficially, the direct color system 2300 reduces material costs. Traditional 3D printing methods require a 1 kilogram ("kg") roll of filament for each color. The cost to purchase 1 kg rolls for 40 colors is prohibitively expensive (at approximately $25 per roll x 40 rolls = $1,000). With the direct color system 2300 described herein a user could achieve well over 8,000+ colors for around 20% of the cost. Furthermore, the direct color system 2300 only requires having small quantities of inexpensive colorant powders (around 0.5 kg each) and one 40 kg bag of raw plastic pellets for a total of about $200. Storage of 40 rolls of filament is problematic, whereas storage of colorant powder and pellets is manageable.

Note that the color dispensers 100 are scalable where the size of each color dispenser 100, the mounting bracket 702, the filament feeder 1902, etc. are able to scale to fit a particular 3D printer. Thus, for an industrial 3D printer, the sizes of the each color dispenser 100, the mounting bracket 702, the filament feeder 1902, etc. may be increased to fit the industrial 3D printer. In other embodiments, the color dispensers 100 and mounting bracket 702 may be kept the same size for a larger 3D printer where the color dispensers 100 run more frequently to account for the increased size of the 3D printer.

Beneficially, the direct color system 2300 reduces purging. With conventional filament-based 3D printing methods hundreds of grams of material need to be purged from the material feed system in order to change colors or materials. This purge requires the print job to stop and the 3D printer, such as a filament extruder, puts out a large amount of material off to the side as waste. The amount of material purged with conventional methods is often equal to or greater than the material used for the printed article, which also wastes time and electricity. With the novel direct color system 2300 outlined herein, it is possible to change colors in real-time while printing continually uninterrupted with zero material purged. This direct color system 2300 technology can thus eliminate material purges related to color changes, which contributes to further additional savings of material, time and electricity. Color changes and additive mixing take place rapidly with this system due to the close proximity of the colorant addition to the point of extrusion.

Beneficially, using pellets reduces cost. Not only is the cost of raw plastic pellets a fraction of the cost of filament, the filament itself is supplied on plastic spools which may or may not be recyclable themselves, and adds shipping weight to the filament thereby further contributing to the carbon footprint and glut of plastic entering the environment. It takes energy and resources to manufacture the plastic spools themselves. Using raw pellets to 3D print saves money, space and is ecologically more sound. Less waste is generated simply by the reduction of packaging and shipping materials. That is less waste to go into the landfill or into the environment and less waste to be reclaimed and recycled.

It takes less resources and energy to produce raw plastic pellets than it does to convert raw plastic pellets into filament, put it on a spool and ship it with the added weight of the spool and its packaging. Savings in shipping by overall weight reduction are realized as a result of this.

Another method for adding colorant to a pellet fed 3D printing process is to premix ~1% of concentrated multi-purpose colorant pellets with the raw plastic pellets. These concentrated colorant pellets are sold under the trade name "Masterbatch". Drawbacks of this method of colorant introduction to the pellet printing process include the high cost of the Masterbatch pellets. Another drawback is that a quantity of Masterbatch is required for each and every color that is desired to be printed. The cost for quantities of 40 colors of Masterbatch would add up very quickly would be cumbersome. This is true because mixing masterbatch colors results in a nonuniform mixing of the colors in the melt zone, resulting in unpredictable, nonrepeatable print outcomes as a result. So it is not possible to achieve consistent colors by mixing two or more Masterbatch colors together. Additionally, to change colors requires a full purge of all pellets which results in waste amounts ranging from 200 grams to 2 kg. Alternatively, as mentioned previously our design can change colors with no purge, or if one does wish to purge it, it can be purged with as little as 50 grams of material or less.

Space savings are also realized due to less space in the shop required for storage and inventory. Shop space is at a premium in most homes. Being able to utilize a pellet extruder 3D printer 1000, 1200, 1300 to also utilize conventional 3D printing filament further reduces barrier to this recycling technology to being adopted by more people. This eliminates the need to own a filament- based 3D printer, which allows the user to still use filament they made already own or need to use. The addition of the filament feeder 1902 also unlocks possibilities that have not yet been explored. The hope is to have an impact on the acceptance of decentralized recycling and to reusing waste to manufacture usable items. Furthermore, this could make the transition from filament to pellet usage easier for people, which is more environmentally sound.

FIG. 25 is a diagram of a graphical user interface 2500 for the 3D printer 1000, 1200, 1300 with color dispensers 100, according to various embodiments. The GUI 2500 includes a settings section with selected colors 2502 and advanced settings with a period 2504 in terms of minutes and a concentration 2505 of the powdered substance. Another advanced setting is trim 2506 to adjust concentration of cyan, magenta, and yellow. In some embodiments, the GUI 2500 includes a color selection field 2508 that allows a user to select various colors. In some embodiments, the GUI 2500 includes a preview image field 2510 that displays the object being printed. One of skill in the art will recognize other field and functions to be included in a GUI.

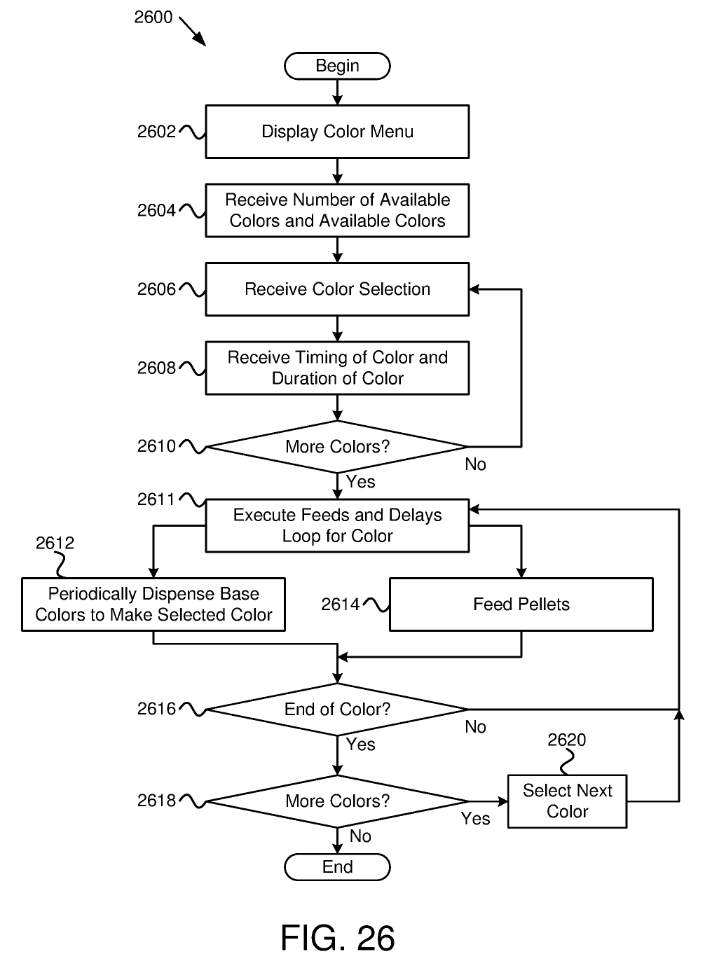

FIG. 26 is a schematic flowchart diagram illustrating a method 2600 for using a 3D printer 1000, 1200, 1300 with color dispensers 100, according to various embodiments. The method 2600 begins and displays 2602 a color menu, such as the GUI 2500 of FIG. 25, and receives 2604 a number of available colors which colors are available. In some examples, the method 2600 receives 2604 that the number of available colors is three where the colors are cyan, magenta, and yellow with one color per color dispenser 100. In other embodiments, there are numerous available colors, each made up of cyan, magenta, and yellow. In other embodiments, the method 2600 allows a user to select a custom color not available from a menu of colors.

The method 2600 receives 2606 from a user a color selection for a first color and receives 2608 timing of the first color (e.g., at what time the color will start) and a duration of the color, for example, in minutes. The method 2600 determines 2610 if there are more colors. If the method 2600 determines 2610 that there are more colors, the method 2600 returns and receives 2606 another color and receives 2608 timing of the color and duration of the color. If the method 2600 determines 2610 that there are no more colors, the method 2600 executes 2611 a feeds and delays loop for a color. The method 2600 periodically dispenses 2612 base powdered substance to make up the selected color and simultaneously feeds 2614 pellets, or in the case of a filament feeder 1902, feeds 2614 filament.

The method 2600 determines 2616 if it is time to end the selected color. If the method 2600 determines 2616 that it is not time to end the selected color, the method 2600 returns and continues to execute 2611 the feeds and delays loop for the selected color. If the method 2600 determines 2616 that it is time to end the selected color, the method 2600 determines 2618 if there are additional selected colors. If the method 2600 determines 2618 that there are one or more additional colors, the method 2600 selects 2620 the next color to be printed and returns to execute 2611 the feeds and delays loop for that color. If the method 2600 determines 2618 that there are no more selected colors, the method 2600 ends. In various embodiments, all or a portion of the method 2600 is implemented using the controller module 2309 and/or the direct color algorithm.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
one or more color dispensers, each comprising a hopper, a color auger, and a color auger motor coupled to the color auger, the color auger configured to rotate and feed a powdered substance from the hopper out a nozzle into a chamber of a three-dimensional (“3D”) printer;
a mounting bracket comprising a nozzle opening for each of the one or more color dispensers, the mounting bracket configured to mount to a side of the chamber of the 3D printer, wherein the 3D printer is configured to comprise a chamber opening corresponding to at least each nozzle opening; and
a controller module configured to signal each color auger motor to rotate to deliver a prescribed amount of the powdered substance to the chamber of the 3D printer, wherein a main auger of the 3D printer mixes the powdered substance with printing material to color the printing material and/or to add an additive to the printing material.

2. The apparatus of claim 1, wherein the one or more color dispensers comprise two or more color dispensers and wherein the controller module is configured to combine different color powdered substances from the two or more color dispensers to provide a printing material colored using a mixture of the powdered substances from the two or more color dispensers.

3. The apparatus of claim 2, wherein the two or more color dispensers with the powdered substance comprise a color dispenser with comprising a cyan powder, a color dispenser
comprising a magenta color powder, and a color dispenser comprising a yellow color powder, wherein the controller module is configured to mix the cyan color powder, the magenta color powder, and the yellow color powder to achieve a desired color from a cyan- magenta-yellow ("CMY") color scheme.

4. The apparatus of claim 1, wherein each of the one or more color dispensers comprises a vibrating motor configured to vibrate the color dispenser during operation of the color auger of the color dispenser.

5. The apparatus of claim 1, further comprising an extension hopper configured to couple to a top of the hopper of a color dispenser of the one or more color dispensers, the extension hopper configured to add additional capacity to the color dispenser for the powdered substance.

6. The apparatus of claim 5, wherein the extension hopper is configured to be stackable,wherein two or more extension hoppers are connectable to the hopper of the one or more color dispensers.

7. The apparatus of claim 1, wherein the controller module is configured to interface with executable code of the 3D printer, wherein the controller module provides a graphical user interface ("GUI") comprising fields configured to be modified by a user to program color information for various parts of an object being printed.

8. The apparatus of claim 1, wherein the 3D printer is configured for 3D printing pellets.

9. The apparatus of claim 1, further comprising a filament feeder attached to the 3D printer, the filament feeder configured to feed a filament into the chamber in place of 3D printing pellets.

10. The apparatus of claim 9, wherein the filament feeder comprises a filament mounting bracket, a roller, and a filament motor, the filament motor configured to rotate the roller as directed by the controller module to feed the filament into the chamber, wherein the filament mounting bracket is mounted to the 3D printer above the chamber and wherein the 3D printer is modified to comprise a filament opening corresponding with the filament mounting bracket.

11. The apparatus of claim 1, wherein the one or more color dispensers each comprise a wedge shape with a narrow portion of the wedge shape at the nozzle.

12. The apparatus of claim 1, further comprising a camera directed into the chamber, the camera providing a view of the interior of the chamber.

13. An apparatus comprising:a filament feeder comprising a filament mounting bracket, a roller, and a filament motor, the filament motor configured to rotate the roller to feed the filament into a chamber of a three-dimensional ("3D") printer, wherein the filament mounting bracket is mounted to the 3D printer above the chamber and wherein the 3D printer is modified to comprise a filament opening corresponding with the filament mounting bracket; and
a controller module configured to signal the filament motor to feed the filament into the chamber of the 3D printer.

14. The apparatus of claim 13, further comprising:one or more color dispensers, each comprising a hopper, a color auger, and a color auger motor coupled to the color auger, the color auger configured to rotate and feed a powdered substance from the hopper out a nozzle into a chamber of the 3D printer; anda mounting bracket comprising a nozzle opening for each of the one or more color dispensers, the mounting bracket configured to mount to a side of the chamber of the 3D printer, wherein the 3D printer is configured to comprise a chamber opening corresponding to at least each nozzle opening, wherein the controller module is further configured to signal each color auger motor to rotate to deliver a prescribed amount of the powdered substance to the chamber of the 3D printer, wherein a main auger of the 3D printer mixes the powdered substance with printing material to color the printing material and/or to add additive to the printing material.

15. The apparatus of claim 13, wherein the one or more color dispensers comprise two or more color dispensers and wherein the controller module is configured to combine the powdered substance from the two or more to provide a printing material colored using a mixture of the powdered substance from the two or more color dispensers.

16. The apparatus of claim 13, wherein each of the one or more color dispensers comprises a vibrating motor configured to vibrate the color dispenser during operation of the color auger of the color dispenser.

17. The apparatus of claim 13, wherein each of the one or more hoppers further comprises an extension hopper configured to couple to a top of the hopper of a color dispenser of the one or more color dispensers, the extension hopper configured to add additional capacity to the color dispenser for powdered substance.

18. The apparatus of claim 13, wherein the controller module is configured to interface with executable code of the 3D printer, wherein the controller module provides a graphical user interface ("GUI") comprising fields configured to be modified by a user to program color information for various parts of an object being printed.

19. An apparatus comprising:one or more color dispensers, each comprising a hopper, a color auger, a color auger motor coupled to the color auger, and a vibrating motor, the color auger motor configured to rotate the color auger and feed powdered substance from the hopper out a nozzle into a chamber of a three-dimensional ("3D") printer, wherein the vibrating motor is configured to vibrate the color dispenser during operation of the color auger of the color dispenser;a mounting bracket comprising a nozzle opening for three color dispensers, the mounting bracket configured to mount to a side of the chamber of the 3D
printer, wherein the 3D printer is modified to comprise a chamber opening corresponding to at least each of three nozzle openings; and a controller module configured to signal each color auger motor to rotate to deliver a prescribed amount of powdered substance to the chamber of the 3D printer, wherein a main auger of the 3D printer mixes the powdered substance with printing material to color the printing material and/or to add an additive to the printing material,
wherein the controller module is configured to interface with executable code of the 3D printer, wherein the controller module provides a graphical user interface ("GUI") comprising fields configured to be modified by a user to program color information for various parts of an object being printed.

20. The apparatus of claim 19, further comprising:an extension hopper configured to couple to a top of the hopper of a color dispenser of the one or more color dispensers, the extension hopper configured to add additional capacity to the color dispenser for powdered substance; and/or a filament feeder attached to the 3D printer, the filament feeder configured to feed a filament into the chamber in place of 3D printing pellets.
